(19) United States
(12) Patent Application Publication
(10) Pub. No.: US 2026/0352282 A1
(43) Pub. Date: Nov. 5, 2026

(54) MULTIPLE TRANSMISSION RECEPTION POINT COHERENT JOINT TRANSMISSION CHANNEL STATE INFORMATION REPORTING

(71) Applicant: QUALCOMM Incorporated, San Diego, CA (US)

(72) Inventors: Min HUANG, Beijing (CN); Jing DAI, Beijing (CN); Liangming WU, Beijing (CN)

(21) Appl. No.: 19/109,429

(22) PCT Filed: Nov. 2, 2022
(86) PCT No.: PCT/CN2022/129158

§ 371 Date: Mar. 6, 2025

(51) Int. Cl. H04B 7/06; H04L 25/02; H04W 72/044

(52) U.S. Cl. CPC H04B 7/0626; H04B 7/0639; H04L 25/0224; H04W 72/044

(57) ABSTRACT

Various aspects of the present disclosure generally relate to wireless communication. In some aspects, an UE may receive configuration information associated with reporting channel state information (CSI) associated with a plurality of transmission reception points (TRPs) for multiple TRP (mTRP) coherent joint transmission (CJT), the CSI including, for each of the plurality of TRPs, frequency domain (FD) basis information associated with a port selection codebook, spatial domain (SD) basis information associated with the port selection codebook, and non-zero coefficient (NZC) information associated with the port selection codebook. The UE may receive a plurality of precoded channel state information (CSI)-reference signals (CSI-RSs) from the plurality of TRPs, wherein each of the plurality of precoded CSI-RSs is based on an SD precoding operation and an FD precoding operation. The UE may transmit a reporting communication based on the configuration information and the plurality of precoded CSI-RSs. Numerous other aspects are provided.

### FIELD OF THE DISCLOSURE

Aspects of the present disclosure generally relate to wireless communication and specifically, to techniques and apparatuses for channel state information reporting.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

While Type-II channel state information (CSI) port selection codebooks have been developed for single transmission reception point (TRP) scenarios, in a multiple (TRP) (mTRP) coherent joint transmission (CJT) scenario, due to possible different propagation delays among TRPs, even though frequency domain (FD) precoded CSI-reference signals (CSI-RSs) can be transmitted, when a UE reports a precoding matrix indicator (PMI), the FD basis selection for mTRP may not fully compensate inter-TRP path delay differences. Moreover, spatial domain (SD) basis reporting and non-zero coefficient (NZC) reporting in some Type-II codebooks are configured for single TRP port selection CSI, and thus can be ineffective for mTRP scenarios.

### SUMMARY

Some aspects described herein relate to a user equipment (UE) for wireless communication. The user equipment may include at least one memory and at least one processor communicatively coupled with the at least one memory. The at least one processor may be operable to cause the user equipment to receive configuration information associated with reporting channel state information (CSI) associated with a plurality of transmission reception points (TRPs) for multiple TRP (mTRP) coherent joint transmission (CJT), the CSI including, for each of the plurality of TRPs, frequency domain (FD) basis information associated with a port selection codebook, spatial domain (SD) basis information associated with the port selection codebook, and non-zero coefficient (NZC) information associated with the port selection codebook. The at least one processor may be operable to cause the user equipment to receive a plurality of precoded CSI-reference signals (CSI-RSs) from the plurality of TRPs, wherein each of the plurality of precoded CSI-RSs is based on an SD precoding operation and an FD precoding operation. The at least one processor may be operable to cause the user equipment to transmit a reporting communication based on the configuration information and the plurality of precoded CSI-RSs.

Some aspects described herein relate to a network node for wireless communication. The network node may include at least one memory and at least one processor communicatively coupled with the at least one memory. The at least one processor may be operable to cause the network node to transmit configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The at least one processor may be operable to cause the network node to transmit a plurality of precoded CSI-RSs from the plurality of TRPs, wherein each of the plurality of precoded CSI-RSs is based on an SD precoding operation and an FD precoding operation. The at least one processor may be operable to cause the network node to receive a reporting communication based on the configuration information and the plurality of precoded CSI-RSs.

Some aspects described herein relate to an apparatus for wireless communication. The apparatus may include means for receiving configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The apparatus may include means for receiving a plurality of precoded CSI-RSs from the plurality of TRPs, wherein each of the plurality of precoded CSI-RSs is based on an SD precoding operation and an FD precoding operation. The apparatus may include means for transmitting a reporting communication based on the configuration information and the plurality of precoded CSI-RSs.

Some aspects described herein relate to an apparatus for wireless communication. The apparatus may include means for transmitting configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The apparatus may include means for transmitting a plurality of precoded CSI-RSs from the plurality of TRPs, wherein each of the plurality of precoded CSI-RSs is based on an SD precoding operation and an FD precoding operation. The apparatus may include means for receiving a reporting communication based on the configuration information and the plurality of precoded CSI-RSs.

Some aspects described herein relate to a method of wireless communication performed by an apparatus at a UE. The method may include receiving configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The method may include receiving a plurality of precoded CSI-RSs from the plurality of TRPs, wherein each of the plurality of precoded CSI-RSs is based on an SD precoding operation and an FD precoding operation. The method may include transmitting a reporting communication based on the configuration information and the plurality of precoded CSI-RSs.

Some aspects described herein relate to a method of wireless communication performed by an apparatus at a network node. The method may include transmitting configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The method may include transmitting a plurality of precoded CSI-RSs from the plurality of TRPs, wherein each of the plurality of precoded CSI-RSs is based on an SD precoding operation and an FD precoding operation. The method may include receiving a reporting communication based on the configuration information and the plurality of precoded CSI-RSs.

Some aspects described herein relate to a non-transitory computer-readable medium that stores a set of instructions for wireless communication by a UE. The set of instructions, when executed by one or more processors of the UE, may cause the UE to receive configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The set of instructions, when executed by one or more processors of the UE, may cause the UE to receive a plurality of precoded CSI-RSs from the plurality of TRPs, wherein each of the plurality of precoded CSI-RSs is based on an SD precoding operation and an FD precoding operation. The set of instructions, when executed by one or more processors of the UE, may cause the UE to transmit a reporting communication based on the configuration information and the plurality of precoded CSI-RSs.

Some aspects described herein relate to a non-transitory computer-readable medium that stores a set of instructions for wireless communication by a network node. The set of instructions, when executed by one or more processors of the network node, may cause the network node to transmit configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The set of instructions, when executed by one or more processors of the network node, may cause the network node to transmit a plurality of precoded CSI-RSs from the plurality of TRPs, wherein each of the plurality of precoded CSI-RSs is based on an SD precoding operation and an FD precoding operation. The set of instructions, when executed by one or more processors of the network node, may cause the network node to receive a reporting communication based on the configuration information and the plurality of precoded CSI-RSs.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example disaggregated base station architecture in accordance with the present disclosure.

FIG. 4 is a diagram illustrating an example of multiple transmission reception point (mTRP) communication in accordance with the present disclosure.

FIG. 5 is a diagram illustrating an example associated with mTRP coherent joint transmission (CJT) channel state information (CSI) reporting in accordance with the present disclosure.

FIG. 6 is a flowchart illustrating an example process performed, for example, by a UE in accordance with the present disclosure.

FIG. 7 is a flowchart illustrating an example process performed, for example, by a network node in accordance with the present disclosure.

FIG. 8 is a diagram of an example apparatus for wireless communication in accordance with the present disclosure.

FIG. 9 is a diagram of an example apparatus for wireless communication in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Various aspects relate generally to reporting frequency domain (FD) basis information, spatial domain (SD) basis information, and non-zero coefficient (NZC) information associated with a port selection codebook for Type-II channel state information (CSI) associated with multiple transmission reception point (mTRP) coherent joint transmission (CJT). Some aspects more specifically relate to receiving, at a user equipment (UE), configuration information associated with reporting CSI associated with a plurality of transmission reception points (TRPs) for mTRP CJT and reporting the CSI based on receiving a plurality of CSI-reference signals (CSI-RSs) that are precoded based on an SD precoding operation and an FD precoding operation. In some aspects, the UE may report the CSI using an mTRP CJT CSI report including a further enhanced (Fe) Type-II port selection codebook. In some aspects, the FD precoding operation may be associated with an FD precoding mode. The FD precoding mode may indicate whether the FD precoding operation is based on a path delay difference associated with one TRP, a partial set of TRPs, or a full set of TRPs. In some aspects, the configuration information may indicate a total quantity of UE-selected and/or selectable CSI-RS ports associated with the plurality of TRPs. In some aspects, the SD basis information may indicate a selection value associated with selection of one or more CSI-RS ports. The configuration information may indicate a quantity of NZCs associated with the plurality of TRPs, and the NZC information may indicate selection of NZCs for the codebook.

Particular aspects of the subject matter described in this disclosure can be implemented to realize one or more of the following potential advantages. In some examples, the described techniques can be used to extend FeType-II codebook refinement for mTRP CJT scenarios, thereby providing for CSI acquisition for mTRP CJT. In some examples, the described techniques can be used to facilitate implementation of larger numbers of ports for CJT in low-frequency bands with distributed TRPs.

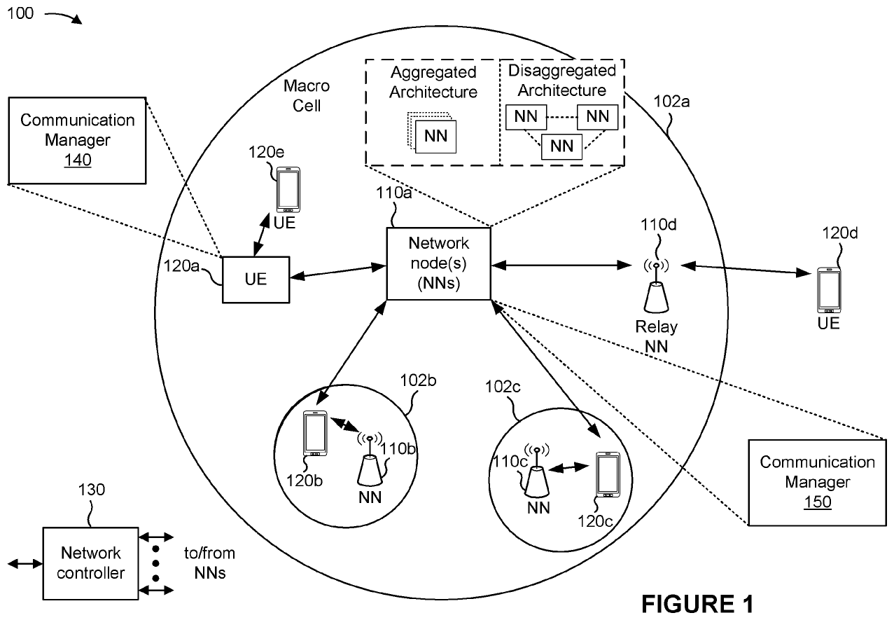

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FRI, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook; receive a plurality of precoded CSI-RSs from the plurality of TRPs, wherein each of the plurality of precoded CSI-RSs is based on an SD precoding operation and an FD precoding operation; and transmit a reporting communication based on the configuration information and the plurality of precoded CSI-RSs. Additionally, or alternatively, the communication manager 140 may perform one or more other operations described herein.

In some aspects, the network node 110 may include a communication manager 150. As described in more detail elsewhere herein, the communication manager 150 may transmit configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook; transmit a plurality of precoded CSI-RSs from the plurality of TRPs, wherein each of the plurality of precoded CSI-RSs is based on an SD precoding operation and an FD precoding operation; and receive a reporting communication based on the configuration information and the plurality of precoded CSI-RSs. Additionally, or alternatively, the communication manager 150 may perform one or more other operations described herein.

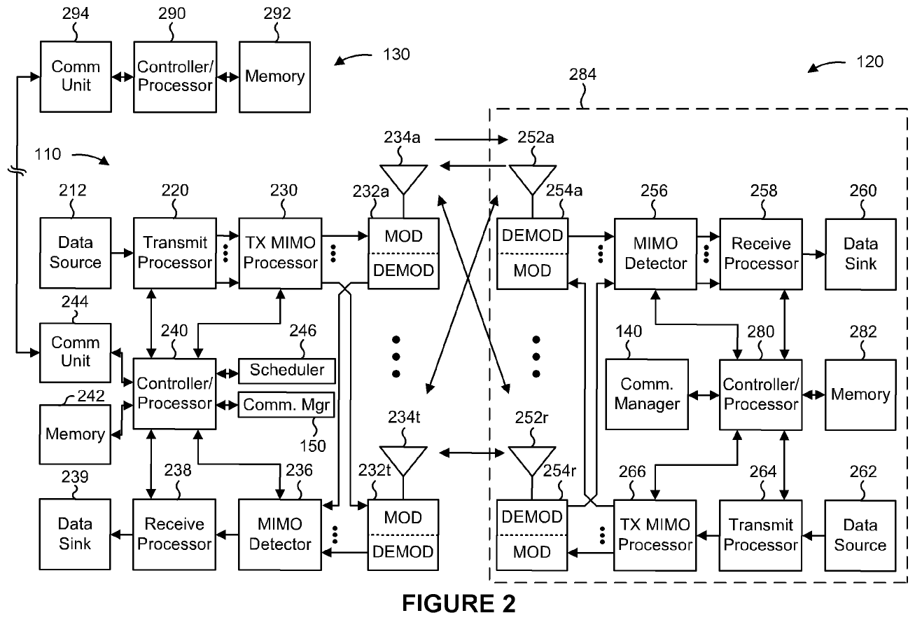

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, Toutput symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

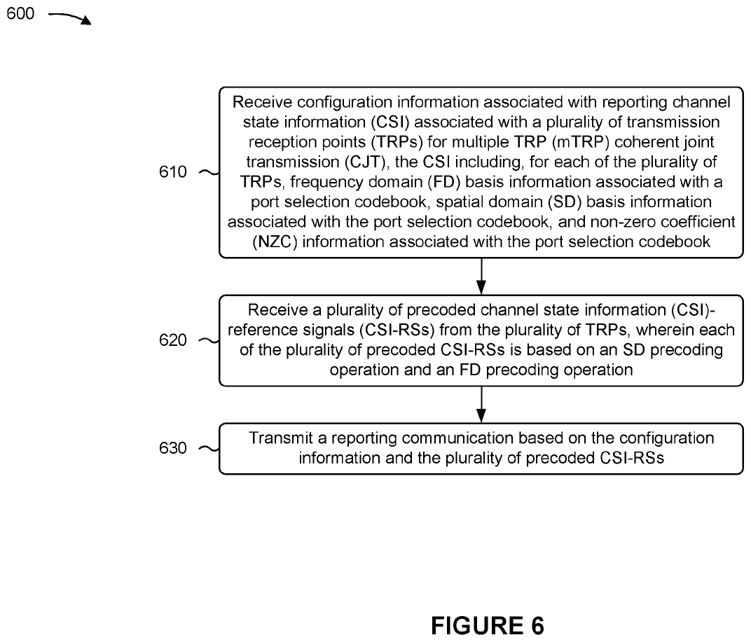

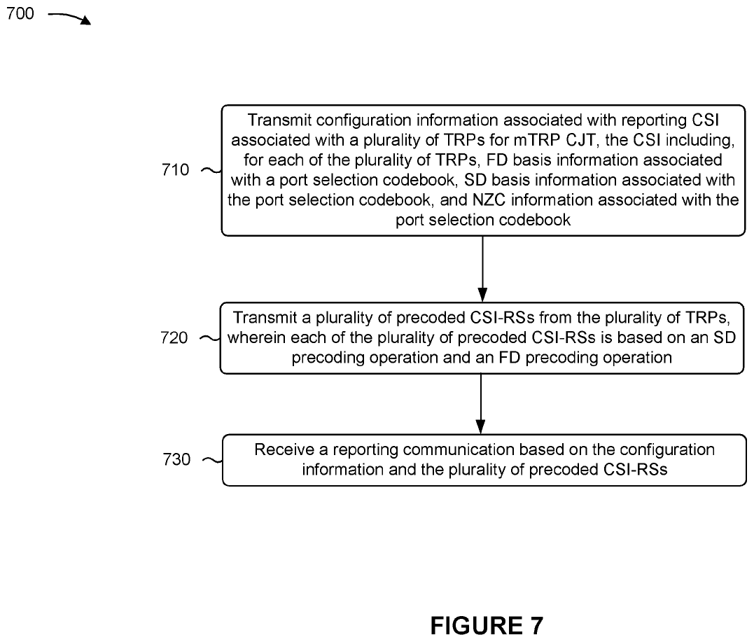

The controller/processor 240 of the network node 110, the controller/processor 280 of the UE 120, or any other component(s) of FIG. 2 may perform one or more techniques associated with mTRP CJT CSI reporting, as described in more detail elsewhere herein. For example, the controller/processor 240 of the network node 110, the controller/processor 280 of the UE 120, or any other component(s) of FIG. 2 may perform or direct operations of, for example, process 600 of FIG. 6, process 700 of FIG. 7, or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 600 of FIG. 6, process 700 of FIG. 7, or other processes as described herein. In some examples, executing instructions may include running the instructions, converting the instructions, compiling the instructions, or interpreting the instructions, among other examples.

In some aspects, the UE includes means for receiving configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook; means for receiving a plurality of precoded CSI-RSs from the plurality of TRPs, wherein each of the plurality of precoded CSI-RSs is based on an SD precoding operation and an FD precoding operation; and/or means for transmitting a reporting communication based on the configuration information and the plurality of precoded CSI-RSs. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node includes means for transmitting configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook; means for transmitting a plurality of precoded CSI-RSs from the plurality of TRPs, wherein each of the plurality of precoded CSI-RSs is based on an SD precoding operation and an FD precoding operation; and/or means for receiving a reporting communication based on the configuration information and the plurality of precoded CSI-RSs. The means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

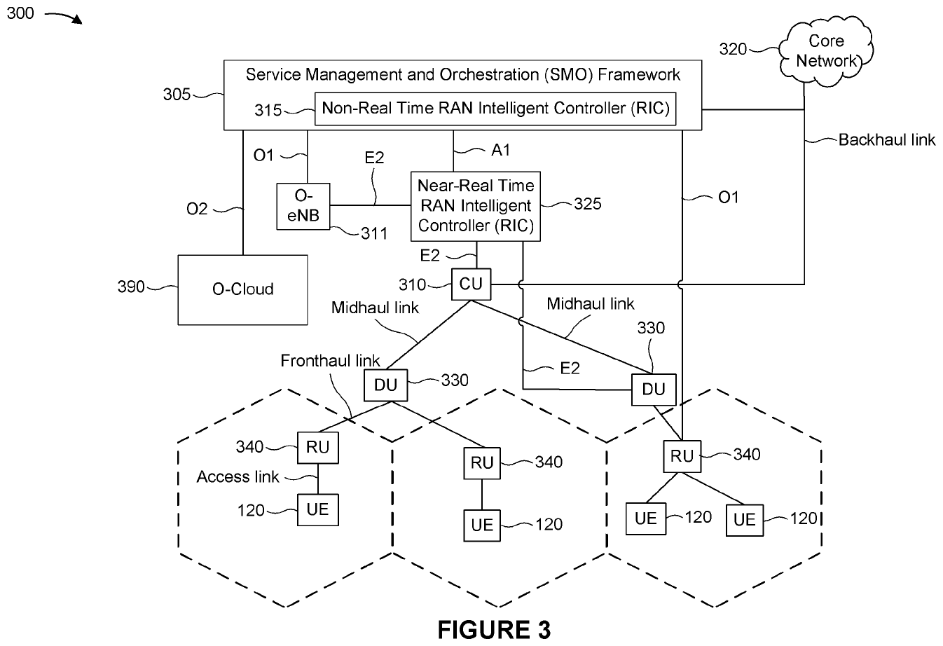

FIG. 3 is a diagram illustrating an example disaggregated base station architecture 300 in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units. In some aspects, the CU 310 may host one or more higher layer control

functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), and/or control plane functionality (for example, Central Unit-Control Plane (CU-CP) functionality). In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

A network node (e.g., network node 110) can transmit many beams to a UE (e.g., UE 120). “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal. For example, the network node can generate the beams using an antenna panel that generates beams at a spatial and/or phase displacement from each other. The network node and the UE can select a set of beams that are to be used for communication between the network node and the UE. For example, the set of beams transmitted from the network node to the UE can be referred to herein as a communication link, a downlink, and/or the like. The communication link between the network node and the UE can propagate in a medium and/or through various geometric paths, which are collectively referred to herein as a channel between the network node and the UE.

In some aspects, the UE can select a set of beams for communication with the network node. For example, the UE can select the set of beams based at least in part on the set of beams being associated with favorable characteristics (e.g., a satisfactory receive power, a satisfactory signal to interference plus noise (SINR) value, etc.). The UE can generate a codeword that indicates the set of beams and parameters to be used for using a codebook based at least in part on performing channel estimation of the channel between the network node and the UE.

One such codebook is the type-II codebook, prescribed in 5G/NR. The type-II codebook can use a two-stage procedure to generate the codeword: a first stage wherein the set of beams is selected for a wideband of the communication link (e.g., sometimes referred to herein as W1), and a second stage wherein linear combination is performed, for a set of subbands, using the set of beams for each set of subbands. The codeword can be based at least in part on the linear combination, and can indicate the set of beams and/or respective amplitudes, phase coefficients, and/or the like. Thus, the UE can provide an indication of channel state at the UE and can request the set of beams to be used for the UE. The type-II codebook can provide more precise specification of the channel state than a type-I codebook, which can provide a predefined codeword-based approach to specifying selected beams. Thus, the type-II codebook can be referred to as a high resolution codebook in comparison to the type-I codebook. The type-II codebook can improve multi-user multiple input multiple output (MU-MIMO) performance on the communication link.

For one type of type-II codebook (e.g., the codebook specified in Release 15 of the 3GPP standard for 5G/NR), the precoder of the codebook is based at least in part on a linear combination of discrete Fourier transform (DFT) beams. The linear combination may define the precoder W as W=W₁W₂, wherein the spatial domain compression matrix

$${W}_{1} = [ \begin{matrix}{v}_{0} {v}_{1} … {v}_{L - 1} & 0 \\ 0 & {v}_{0} {v}_{1} … {v}_{L - 1}\end{matrix} ] ,$$

wherein

$${\{ {v}_{i} \}}_{i = 0}^{L - 1}$$

are L spatial domain basis vectors of dimension N₁N₂×1 (mapped to the two polarizations, so 2L in total), P=2N₁N₂ indicates a number of dimensions (sometimes represented as D), and the combination coefficient matrix W₂ is composed of K=2Lu linear combination coefficients, where v indicates a total number of layers. Each column in W₂ indicates the linear combination of complex coefficients (i.e., amplitude and phase) for one layer, wherein the amplitude coefficient is given by

$${\{ {p}_{i}^{( 1 )} {p}_{i}^{( 2 )} \}}_{i = 0}^{2 L - 1}$$

for l=0, . . . , v−1, and

$${p}_{i}^{( 1 )} and {p}_{i}^{( 2 )}$$

are the wideband and subband coefficients, respectively. The phase coefficient is given by

$${\{ {c}_{l , i} \}}_{i = 0}^{2 L - 1}$$

for l=0, . . . , v−1, and cₗ is one of the 8 phase shift keying (8PSK) or the quadrature phase shift keying (QPSK) constellation points.

The UE can report the above values and/or other values associated with channel estimation using CSI feedback. CSI feedback for the type-II codebook can include two parts: a first part, sometimes referred to as CSI part I, and a second part, sometimes referred to as CSI part II. In some cases, the first part can have a smaller payload than the second part, and/or can have a fixed payload. For example, the first part can have a payload size of less than approximately 50 bits, whereas the second part can have a variable payload size that may be dependent on the first part. In some cases, the second part can have a payload size of approximately 100 bits to 600 bits, although other values can be used.

In some cases, the first part can identify one or more of: a rank indicator (RI) (e.g., 1 bit to indicate one layer v=1 or two layers v=2 when the configured maximum rank is 2); wideband and subband differential channel quality indicators (CQI), for which a total payload size may be dependent on the number of subbands (e.g., approximately 4+18×2=40 bits for 19 subbands); and/or an indication of the number of non-zero wideband amplitude coefficients Qₗ for each layer; among other examples. In some cases, the second part can identify one or more of: wideband and/or subband precoding matrix indicators (PMIs) including a spatial basis vector selection indication; wideband and subband amplitude coefficients; and/or subband phase coefficients; among other examples.

In some cases, the type-II CSI feedback can use a compressed type-II precoder. This can reduce overhead of type-II CSI feedback. The compressed precoder can exploit the sparsity of the spatial domain and/or the frequency domain. For example, an example of a compressed type-II precoder W is given by

$$W = {W}_{1} {\tilde{W}}_{2} {W}_{f}^{H} ,$$

wherein the precoder matrix W has P=2N₁N₂ rows (representing the spatial domain and the number of ports) and N₃ columns (wherein N₃ is a frequency-domain compression unit of resource blocks or reporting subbands). The W₁ matrix, described above, is the spatial basis consisting of L beams per polarization group (hence a total of 2L beams). The \tilde{W}₂ matrix indicates all of the required linear combination complex coefficients (amplitude and co-phasing), similarly to what is described above. The W_{f} matrix is composed of the basis vectors used to perform compression in frequency domain, W_{f}=[f₀f₁ . . . f_{M-1}], where

$${\{ {f}_{m} \}}_{m = 0}^{M - 1}$$

and M size-N₃×1 orthogonal DFT vectors for each spatial basis i=0, . . . , 2L−1. The above type-II CSI feedback may be referred to in some cases as enhanced or modified type-II CSI feedback (e.g., enhanced relative to an approach that does not use basis vectors in the spatial and frequency domains to compress feedback size).

The CSI feedback for this enhanced type-II CSI feedback can include a spatial domain basis vector selection that is similar to the approach described in connection with the type-II CSI feedback configuration. The CSI feedback can further include a frequency-domain (FD) basis subset selection (wherein M out of a total N₃ basis vectors are selected). In some cases, common FD basis vectors for all the 2L spatial beams can be used, which is referred to herein as Alternative 1. In these cases, M basis vectors are dynamically selected and reported. The value of M can be configured by the network or reported by the UE. In other cases, referred to herein as Alternative 2, independent FD basis vectors can be used for each spatial domain basis vector, with potentially different numbers and/or selections of FD basis vectors for each spatial domain basis vector. The total number of FD basis vectors across all the 2L spatial beams can be configured.

The enhanced type-II CSI feedback may further include the FD coefficients (e.g., amplitude and phase) in \tilde{W}₂. For Alternative 1 (the common FD basis vector subset selection), the enhanced type-II CSI feedback can report only a subset K₀<K=2 LM of the coefficients. For Alternative 2 (the independent basis subset selection), the enhanced type-II CSI feedback can report

$$K = {\sum }_{i = 0}^{2 L - 1} {M}_{i}$$

amplitudes ana phase coefficients, wherein Mᵢ is the number of FD basis vectors associated with one spatial beam.

In some cases, a further enhanced type-II (FeType-II) port selection codebook (e.g., the codebook specified in Release 17 of the 3GPP standard for 5G/NR) can be used such as, for example, in connection with CIS-RSs that are precoded in the SD and the FD. In the FeType-II codebook, as a result of applying SD and FD precoded CSI-RSs, most or all of the path delays can be compensated in the CSI-RS ports, so that when UE reports PMI, an FD basis 0 (all-one vector) should be selected, i.e.,

$${n}_{3}^{( 0 )} = 0 ;$$

the other candidate FD bases should be close to FD basis 0 (e.g., the number of candidate (N)=2 or 4, the candidate FD basis index set={0,1,2}); and the number of selected FD bases (M)=1 or 2. In this way, the number of columns in W₂ becomes small, and thus the overhead of an FD basis report can be reduced compared with the enhanced Type-II codebook.

A UE can communicate with a number of TRPs using beams. A TRP is a network node configured to transmit and receive signals. For example, a TRP can include one or more components of a base station. In some cases, a UE can communicate with multiple TRPs simultaneously (e.g., at the same time) in accordance with a mTRP configuration. In mTRP downlink communications, the UE can receive a number of communications, each from a different TRP.

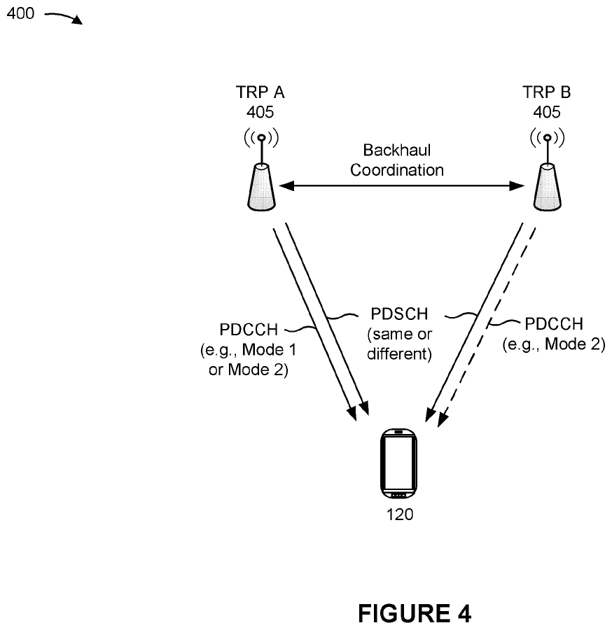

FIG. 4 is a diagram illustrating an example 400 of mTRP communication (sometimes referred to as multi-panel communication), in accordance with the present disclosure. As shown in FIG. 4, multiple TRPs 405 can communicate with the same UE 120. A network node can include multiple TRPs 405, or multiple TRPs 405 can be distributed across multiple network nodes.

The multiple TRPs 405 (shown as TRP A and TRP B) can communicate with the same UE 120 in a coordinated manner (e.g., using coordinated multipoint transmissions) to improve reliability and/or increase throughput. The TRPs 405 can coordinate such communications via an interface between the TRPs 405 (e.g., a backhaul interface and/or an access node controller). The interface can have a smaller delay and/or higher capacity when the TRPs 405 are co-located at the same network node (e.g., when the TRPs 405 are different antenna arrays or panels of the same network node), and can have a larger delay and/or lower capacity (as compared to co-location) when the TRPs 405 are located at different network nodes. The different TRPs 405 can communicate with the UE 120 using different quasi co-location (QCL) relationships (e.g., different transmission configuration indicator (TCI) states), different DMRS ports, and/or different layers (e.g., of a multi-layer communication).

In a first multi-TRP transmission mode (e.g., Mode 1), a single physical downlink control channel (PDCCH) can be used to schedule downlink data communications for a single physical downlink shared channel (PDSCH). In this case, multiple TRPs 405 (e.g., TRP A and TRP B) can transmit communications to the UE 120 on the same PDSCH. For example, a communication can be transmitted using a single codeword with different spatial layers for different TRPs 405 (e.g., where one codeword maps to a first set of layers transmitted by a first TRP 405 and maps to a second set of layers transmitted by a second TRP 405). As another example, a communication can be transmitted using multiple codewords, where different codewords are transmitted by different TRPs 405 (e.g., using different sets of layers). In either case, different TRPs 405 can use different QCL relationships (e.g., different TCI states) for different DMRS ports corresponding to different layers. For example, a first TRP 405 can use a first QCL relationship or a first TCI state for a first set of DMRS ports corresponding to a first set of layers, and a second TRP 405 can use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) can indicate the first QCL relationship (e.g., by indicating a first TCI state) and the second QCL relationship (e.g., by indicating a second TCI state). The first and the second TCI states can be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs can be used to schedule downlink data communications for multiple corresponding PDSCHs (e.g., one PDCCH for each PDSCH). In this case, a first PDCCH can schedule a first codeword to be transmitted by a first TRP 405, and a second PDCCH can schedule a second codeword to be transmitted by a second TRP 405. Furthermore, first DCI (e.g., transmitted by the first TRP 405) can schedule a first PDSCH communication associated with a first set of DMRS ports with a first QCL relationship (e.g., indicated by a first TCI state) for the first TRP 405, and second DCI (e.g., transmitted by the second TRP 405) can schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) can indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

Each communication in an mTRP configuration can be a spatial layer of a joint communication associated with a physical downlink shared channel (PDSCH). A joint communication is a communication that includes more than one signal that shares one or more time resources. Each TRP can be disposed at a different location than each other TRP and, as a result, each respective communication can be associated with one or more different respective spatial resources. Thus, each respective communication can be a spatial layer of the joint communication. A spatial layer of a joint communication is a portion of the joint communication that corresponds to a set of spatial resources. For example, a joint communication can include a first spatial layer corresponding to a first set of spatial resources and a second spatial layer corresponding to a second set of spatial resources.

To receive a joint communication from the multiple TRPs, a single wide beam corresponding to a single transmission configuration indicator (TCI) state can be used. However, the single wide beam can result in application of a single spatial filter that applies to all of the layers of the joint communication, which may not be coherent (e.g., the layers of the joint communication may not have respective phases such that the layers can be constructively combined at a receiving device). A spatial filter is a mechanism (e.g., a process, procedure, circuitry, and/or software, among other examples) used to direct an electromagnetic signal into a certain path. In some cases, a CJT configuration can be used for a coherent joint communication to facilitate more efficient application of spatial filters, which can result in fewer missed signals and more spectral efficiency.

A CJT configuration can be used for PDSCH communications, physical uplink control channel (PUCCH) communications, and/or physical uplink shared channel (PUSCH) communications. A CJT is a joint transmission in which each layer of the joint transmission is transmitted with a respective phase such that the layers can be constructively combined at a receiving device.

In some cases, an mTRP CJT codebook can be used for port selection in mTRP CJT scenarios. In some cases, the mTRP CJT codebook can be from the Rel-16 eType-II CSI codebook or the Rel-17 FeType-II CSI port selection codebook. One of the differences of FeType-II codebook compared with the eType-II codebook is the FD basis selection. In the eType-II codebook, when N₃≤19, the FD bases is arbitrarily selected in the whole FD domain and when N₃>19, the FD basis is selected in a rather large window in the two sides of FD basis 0. In the FeType-II codebook, regardless of the number of PMI Subbands (N₃), when M=2, the FD basis selection window is basis {0,1} (when N=2) or {0,1,2,3} (when N=4). Thus, FD basis 0 is always selected and the other candidate bases are close to basis 0 (e.g., each FD basis window starts from FD basis 0).

However, in the mTRP CJT scenario, due to possible different propagation delays among TRPs, even though FD precoded CSI-RS can be transmitted, when a UE reports PMI, the FD basis selection for mTRP may not all be always close to FD basis 0. Thus, the FeType-II basis report cannot be used directly for each TRP in mTRP CJT in all the use cases. When a network node transmits CSI-RS at each TRP, the FD precoding may not fully compensate inter-TRP path delay differences. When TRPs are deployed in a distributed manner, the mTRP combination may change such as, for example, due to different multi-UE MIMO scheduling or UE movement. For example, if the FD precoding of one CSI-RS port (for one TRP) fully compensates inter-TRP path delay difference in one mTRP combination, this CSI-RS may introduce partial delay when the TRP is included in another TRP combination. For example, if SD and FD precoded CSI-RS ports are transmitted based on mTRP combination {1,2} or {3,4} respectively, then, when a scheduling changes the mTRP combination to mTRP combination {1,3}, {1,4}, {2,3} or {2,4}, inter-TRP path delay difference can be introduced. In some cases, if a new CSI-RS port with full delay compensation is transmitted for the new mTRP combination, the overhead of CSI-RS can be increased. Thus, for mTRP CJT port selection codebook, every TRP will not necessarily have the FD bases close to FD basis 0. Moreover, SD basis reporting and NZC reporting in the FeType-II codebook are configured for single TRP port selection CSI, and thus can be ineffective for mTRP scenarios.

Various aspects relate generally to reporting FD basis information, SD basis information, and NZC information associated with a port selection codebook for Type-II CSI associated with mTRP CJT. Some aspects more specifically relate to receiving, at a UE, configuration information associated with reporting CSI associated with a plurality of TRPs for mTRP CJT and reporting the CSI based on receiving a plurality of CSI-RSs that are precoded based on an SD precoding operation and an FD precoding operation. In some aspects, the UE may report the CSI using an mTRP CJT CSI report including a further enhanced (Fe) Type-II port selection codebook. In some aspects, the FD precoding operation may be associated with an FD precoding mode. The FD precoding mode may indicate whether the FD precoding operation is based on a path delay difference associated with one TRP, a partial set of TRPs, or a full set of TRPs. In some aspects, the configuration information may indicate a total quantity of UE-selected and/or selectable CSI-RS ports associated with the plurality of TRPs. In some aspects, the SD basis information may indicate a selection value associated with selection of one or more CSI-RS ports. The configuration information may indicate a quantity of NZCs associated with the plurality of TRPs, and the NZC information may indicate selection of NZCs for the codebook.

Particular aspects of the subject matter described in this disclosure can be implemented to realize one or more of the following potential advantages. In some examples, the described techniques can be used to extend FeType-II codebook refinement for mTRP CJT scenarios, thereby providing for CSI acquisition for mTRP CJT. In some examples, the described techniques can be used to facilitate implementation of larger numbers of ports for CJT in low-frequency bands with distributed TRPs.

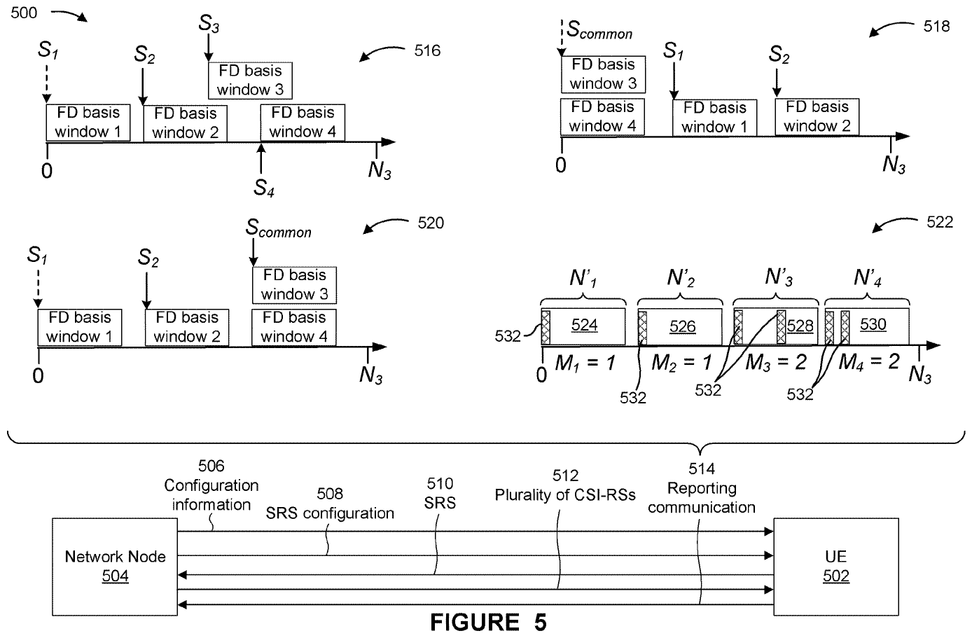

FIG. 5 is a diagram illustrating an example 500 associated with mTRP CJT CSI reporting in accordance with the present disclosure. As shown in FIG. 5, a UE 502 and a network node 504 may communicate with one another. In some aspects, the UE 502 may be, be similar to, include, or be included in, the UE 120 depicted in FIGS. 1-4. In some aspects, the network node 504 may be, be similar to, include, or be included in, the network node 110 depicted in FIGS. 1-4. The network node 504 may be or include a plurality of TRPs.

In a first operation 506, the network node 504 may transmit, and the UE 502 may receive, configuration information. The configuration information may be associated with reporting CSI associated with a plurality of TRPs for mTRP CJT. The CSI may include, for each of the plurality of TRPs, FD basis information associated with a port selection codebook, SD basis information associated with the port selection codebook, and NZC information associated with the port selection codebook. In some aspects, the configuration information may include an indication of one or more FD basis parameters. In some aspects, the configuration information may indicate a total quantity of UE-selected CSI-RS ports associated with the plurality of TRPs.

In some aspects, the configuration information may indicate quantities of selectable CSI-RS ports associated with respective TRPs of the plurality of TRPs. In some aspects, the configuration information may indicate CSI-RS resources associated with respective TRPs of the plurality of TRPs. The quantities of selectable CSI-RS ports associated with respective TRPs of the plurality of TRPs may be indicated by respective port quantity values {P_{CSI-RS,i}}. The configuration information may indicate CSI-RS resources associated with respective TRPs of the plurality of TRPs. In some aspects, quantities of selectable CSI-RS ports associated with respective TRPs of the plurality of TRPs may be based on a port quantity value P_{CSI-RS,commo} common to the plurality of TRPs. In some aspects, the configuration information may indicate quantities P_{CSI-RS,ineffective,i} of ineffective ports associated with respective TRPs of the plurality of TRPs, and the quantities of selectable CSI-RS ports associated with respective TRPs may be based on the port quantity value and the respective quantities of ineffective ports. For example, the quantity of selectable ports for each TRP may be given by P_{CSI-RS,i}=P_{CSI-RS,commo}−P_{CSI-RS,ineffectiv,i}.

In some aspects, the configuration information may indicate a quantity of NZCs associated with the plurality of TRPs. In some aspects, the configuration information may indicate the quantity of NZCs based on indicating coefficient indication values associated with respective TRPs of the plurality of TRPs. The configuration information may indicate the quantity of NZCs based on indicating a total coefficient indication value associated with the plurality of TRPs.

In an operation 508, the network node 504 may transmit, and the UE 502 may receive, an SRS configuration. The SRS configuration may be associated with at least one channel estimation of at least one uplink channel between the UE 502 and at least one TRP of the plurality of TRPs. In an operation 510, the UE 502 may transmit, and the network node 504 may receive, an SRS. The SRS may be based on the SRS configuration and may be used by the network node 504 to generate a channel estimation for generating CSI-RSs.

In an operation 512, the network node 504 may transmit, and the UE 502 may receive, a plurality of CSI-RSs. Each of the plurality of precoded CSI-RSs may be based on an SD precoding operation and an FD precoding operation. In some aspects, a plurality of precoded CSI-RSs may be generated by the network node 504 associated with a set of SD precoding weights and a set of FD precoding weights. Each of the set of SD precoding weights and the set of FD precoding weights may be based on the at least one channel estimation.

For example, the network node 504 may estimate an uplink channel matrix based on the SRS and may determine, based on the estimated uplink channel matrix, a set of paths for each TRP. For each TRP (e.g., TRP i), the network node 504 may determine the SD and FD precoding weights based on the set of paths for the TRP or a set of mTRPs including the TRP. In some aspects, for example, the SD direction and path delay of one path (path l) may be denoted as d_{i,l} and τ_{i,l}, respectively. The SD precoding weight

$${w}_{i , l}^{( S D )}$$

may be determined based on d_{i,l} (including AoA and ZoA). In some aspects, the FD precoding weight

$${w}_{i , l}^{( F D )}$$

may be determined based on the path delays of one TRP {τ_{i,l}}ₗ. For example, where τ_{i,min}=min(τ_{i,1}, τ_{i,2}, . . . ) is the smallest delay for TRP i, Δ_{i,l}=(τ_{i,l}−T_{i,min}). BW is the normalized path delay difference for path l of TRP i, and

$${w}_{i , l}^{( F D )} = [ 1 , {e}^{- j 2 π \frac{{Δ}_{i , l}^{′}}{N}} , {e}^{- j 2 π \frac{2 {Δ}_{i , l}^{′}}{N}} , … ]$$

is the FD precoding weight vector.

In some aspects, an FD precoding weight, associated with a TRP of the plurality of TRPs, of the set of FD precoding weights may be based on a path delay associated with the TRP. In some aspects, an FD precoding weight, associated with a TRP of the plurality of TRPs, of the set of FD precoding weights may be based on a plurality of path delays associated with two or more TRPs of the plurality of TRPs. A CSI-RS of the plurality of precoded CSI-RSs may be associated with a dominant path associated with a TRP of the plurality of TRPs and may be based on an FD precoding weight of the set of FD precoding weights.

For example, the FD precoding weight

$${w}_{i , l}^{( F D )}$$

may be determined based on the path delays of multiple or all TRPs {τ_{i,}}. For example, τₘᵢₙ=min(τ_{1,min}, τ_{2,min}, . . . ) may be the smallest delay for multiple TRPs,

$${Δ}_{i , l}^{′} = ( {τ}_{i , l} - {τ}_{min} ) \cdot BW$$

may be the normalized path delay difference for path l of TRP i, and

$${w}_{i , l}^{( F D )} = [ 1 , {e}^{- j 2 π \frac{{Δ}_{i , l}^{′}}{N}} , {e}^{- j 2 π \frac{2 {Δ}_{i , l}^{′}}{N}} , … ]$$

may be the FD precoding weight vector, where Δ′_{i,l}≥Δ_{i,l}. In some aspects, for each of the dominant paths (with the strongest powers) of each TRP, the network node 504 may transmit one CSI-RS port that is multiplied by a corresponding

$${w}_{i , l}^{( FD )}$$

at respective resource elements (REs) of CSI-RS as the FD precoded CSI-RS. In some aspects, at each RE,

$${w}_{i , l}^{( S D )}$$

may be multiplied to the transmission antennas as the SD+FD precoded CSI-RS.

In an operation 514, the UE 502 may transmit, and the network node 504 may receive, a reporting communication. The reporting communication may be based on the configuration information and the plurality of precoded CSI-RSs. In some aspects, the reporting communication may include an mTRP CJT CSI report including an FeType-II port selection codebook. In some aspects, the FD precoding operation may be associated with an FD precoding mode associated with at least one path delay difference associated with at least one TRP of the plurality of TRPs, and the FD basis information may be based on the FD precoding mode.

In some aspects, for example, the FD basis information may indicate, based on the FD precoding mode comprising a mode in which an FD precoding weight associated with a respective TRP of the plurality of TRPs is based on a respective path delay difference associated with the respective TRP, a TRP index associated with a first TRP, of the plurality of TRPs, associated with an FD basis window having a start position associated with an FD basis 0, and a plurality of FD basis window positions associated with respective TRPs of the plurality of TRPs other than the first TRP. For example, as shown in operation 516, the index of one TRP (denoted as i*) whose FD basis window is fixed to start from FD basis 0, may cost ┌log₂M_{TRP}┐ bits, where M_{TRP} is the number of configured TRPs. The individual FD basis window start positions of other TRPs i≠i*, denoted as Sᵢ, may cost (M_{TRP}−1)┌log₂N₃┐ bits, where N₃ is the number of candidate FD bases.

In some aspects, the FD basis information may indicate, based on the FD precoding mode comprising a mode in which an FD precoding weight associated with a respective TRP of the plurality of TRPs is associated with a plurality of path delay differences associated with respective TRPs of a set of two or more TRPs of the plurality of TRPs, an FD basis window position associated with the set of two or more TRPs, and a respective FD basis window position associated with each TRP of the plurality of TRPs not included in the set of two or more TRPs. For example, as shown in an operation 518, the FD basis windows of the TRPs in the partial set may start with an identical FD basis, and thus, the UE 502 may report the common FD basis window start position of the TRPs in this partial set and the individual FD basis of the other TRPs.

In the operation 518, the FD basis windows associated with TRP 3 and TRP 4 (FD basis window 3 and FD basis window 4, respectively) are included in the partial set and start at basis 0. In that case, the common FD basis starting position associated with the partial set may not be reported. In an operation 520, the common FD basis starting position is not associated with basis 0, and, accordingly, the common FD basis starting position may be reported.

In some aspects, the network node 504 may indicate the indexes of the TRPs in the partial set of TRPs. The UE 502 may treat the set as a virtual TRP in an FD basis report. In some aspects, each FD basis window position associated with the plurality of TRPs may correspond to an FD basis 0 start position based on the FD precoding mode comprising a mode in which an FD precoding weight associated with a respective TRP of the plurality of TRPs is associated with a plurality of path delay differences, each of which may be associated with a respective TRP of the plurality of TRPs. For example, if the FD basis windows of all TRPs start from an FD basis 0, the UE 502 may not report the FD basis window start position of any TRP.

In some aspects, FD basis window length for each TRP may be configured by the network node 504 and/or specified in a wireless communication standard. In some aspects, the FD basis information may include a plurality of selected FD bases associated with a plurality of FD basis windows, where each selected FD basis window of the plurality of FD basis windows may be associated with a respective TRP of the plurality of TRPs. In some aspects, a single FD basis window length N′ may be common to each FD basis window of the plurality of FD basis windows. In some aspects, each FD basis window of the plurality of FD basis windows may have a respective length N′ associated with the respective TRP.

In some aspects, the FD basis information may include a plurality of selected FD bases respectively associated with the plurality of TRPs, and the UE 502 may obtain an indication of one or more FD basis parameters associated with the plurality of selected FD bases. In some aspects, the configuration information may include the indication of the one or more FD basis parameters. In some aspects, the UE 502 may obtain the indication of the FD basis parameter based on accessing a memory associated with the UE 502, wherein the indication of the one or more FD basis parameters is stored in the memory.

In some aspects, the one or more FD basis parameters indicate a quantity of selected FD bases M common to all of the TRPs of the plurality of TRPs. In some aspects, the one or more FD basis parameters indicate a quantity of selected FD bases M₁ associated with each TRP of the plurality of TRPs. In some aspects, the one or more FD basis parameters indicate a maximum quantity Mmax of selected FD bases associated with a TRP of the plurality of TRPs. The FD basis information may indicate a quantity of selected FD bases associated with each TRP of the plurality of TRPs and the one or more FD basis parameters may indicate a total quantity Mtotal of selected FD bases associated with the plurality of TRPs.

In an operation 522, for example, an FD basis window 524 associated with a TRP 1 may be configured with an FD basis window length

$${N}_{1}^{′} ,$$

associated with a TRP 2 may be configured with an FD basis window length

$${N}_{2}^{′} ,$$

an FD basis window 528 associated with a TRP 3 may be configured with an FD basis window length

$${N}_{3}^{′} ,$$

and an FD basis window 530 associated with a TRP 4 may be configured with an FD basis window length

$${N}_{4}^{′} .$$

As shown, the TRPs may be configured with respective numbers of selected FD bases, M₁=1, M₂=1, M₃=2, and M₄=2, where Mₘₐₓ=2, and Mₜₒₜₐₗ=6. The UE 502 may report the number of selected FD bases Mᵢ for each TRP, where Mᵢ≤Mₘₐₓ and the sum of the number of selected FD bases 532 may be not larger than the maximum total number of selected FD bases,

$${\sum }_{i = 1}^{{M}_{TRP}} {M}_{i} \leq {M}_{total} .$$

This selection may cost M_{TRP}[log₂ Mₘₐₓ] bits. If there are two candidate values for Mᵢ, then UE 502 may only identify the TRPs with a specified and/or indicated value in a bitmap in which each bin represents one respective TRP, so the number of cost bits may be decreased to M_{TRP}.

In some aspects, the FD basis information may indicate at least one FD basis i_{1,6}associated with a TRP of the plurality of TRPs, and the at least one FD basis may be based on an FD basis window start position Sᵢ associated with an FD basis window, an FD basis window length

$${N}_{i}^{′}$$

associated with the FD basis window, and a quantity of selected FD bases Mᵢ associated with the TRP. In some aspects, the at least one FD basis may include a first FD basis occurring in the FD basis window after the FD basis window start position. The FD basis information may indicate the FD basis selection based on the at least one FD basis including two or more FD bases. For example, if the number of selected bases is Mᵢ=1, the UE 502 may not report the FD basis selection.

In some aspects, the FD basis information may indicate a respective FD basis index associated with each of the two or more FD bases other than a first FD basis occurring in the FD basis window after the FD basis window start position. For example, for any TRP, if the number of selected FD bases is Mᵢ>1, the UE 502 may report the indexes of the selected FD bases (except the first FD basis) within the FD basis window of this TRP. If one bit is used to identify whether a FD basis in the FD basis window (except the first basis in the window) is selected,

$${N}_{i}^{′} - 1$$

bits may be the cost for TRP i. In total, for all TRPs,

$${\sum }_{i = 1}^{{M}_{TRP}} ( {N}_{i}^{′} - 1 )$$

bits may be the resulting cost. Alternatively, if a selection value is used to identify which FD bases in the FD basis window (except the first basis in the window) are selected,

$$⌈ {log}_{2} ( \begin{matrix}{N}_{i}^{′} - 1 \\ {M}_{i} - 1\end{matrix} )$$

bits may be the resulting cost, where

$$( \begin{matrix}x \\ y\end{matrix} )$$

represents the number of possible selection results of selecting y elements from x elements

$$( x = {N}_{i}^{′} - 1 , and y = {N}_{i}^{′} - 1$$

in this example). If Mᵢ=2, UE may only identify the index of the selected FD basis other than FD basis 0, and, as a result,

$$⌈ {log}_{2} ( {N}_{i}^{′} - 1 ) ⌉$$

bits may be the cost. In total, for all TRPs,

$${\sum }_{i = 1}^{{M}_{TRP}} ⌈ {log}_{2} ( {N}_{i}^{′} - 1 ) ⌉$$

bits may be the resulting cost.

In some aspects, the configuration information may indicate a total quantity of UE-selected CSI-RS ports associated with the plurality of TRPs, and the SD basis information may indicate a selection value associated with selection of one or more CSI-RS ports associated with a TRP of the plurality of TRPs. In some aspects, the configuration information may indicate a quantity of UE-selected CSI-RS ports associated with each TRP of the plurality of TRPs, and the SD basis information may indicate a selection value associated with selection of one or more CSI-RS ports associated with each TRP of the plurality of TRPs. The configuration information may indicate a total quantity of UE-selected CSI-RS ports associated with the plurality of TRPs, and the SD basis information may indicate selection information associated with an allocation of the total quantity of UE-selected CSI-RS ports across the plurality of TRPs. In some aspects, the selection information indicates a quantity of selected CSI-RS ports associated with selection of the selected CSI-RS ports. In some aspects, the selection information may indicate a selection value associated with selection of a set of selected CSI-RS ports from among a set of CSI-RS ports associated with the plurality of TRPs.

For example, in some aspects, the network node 504 may configure, or the UE 502 may report, the number of UE-selected CSI-RS ports in each TRP

$$( {\{ {L}_{i} \}}_{i = 1}^{{M}_{TRP}} ) ,$$

and the UE 502 may report SD basis selection results. In some aspects, the network node 504 may configure the total number of UE-selected CSI-RS ports in all TRPs, Lₜₒₜₐₗ=K₁/2 and K₁=αP_{CSI-RS,total}, where P_{CSI-RS,total} is the total number of CSI-RS ports of all TRPs and configured by the network node 504, α

$$∈ \{ \frac{1}{2} , \frac{3}{4} , 1 \}$$

is configured by the network node 504. A wireless communication standard may specify that the number of UE-selected CSI-RS ports in each TRP may be evenly divided from the configured total number, i.e.,

$${L}_{i} ≡ \frac{{L}_{total}}{{M}_{TRP}} , ∀ i .$$

Then, the UE 502 may report a selection value indicating how to select Lᵢ ports from the P_{CSI-RS,i} CSI-RS ports for TRP i, i=1~M_{TRP}. In this way, the value of P_{CSI-RS,i} may be configured by the network node 504. In some aspects, this operation may be used where the number of CSI-RS ports of each TRP is the same. In some aspects, the network node 504 may explicitly configure the individual number of UE-selected CSI-RS ports Lᵢ for each TRP. For example, the number of CSI-RS ports of each of two or more TRPs may be different. Specifically, the network node 504 may configure the αᵢ value for each TRP i, in which case, Lᵢ=K_{1,i}/2 and K_{1,i}=αᵢP_{CSI-RS,i}. In this way, the number of CSI-RS ports of two polarizations for the ith TRP P_{CSI-RS,i} is configured by the network node 504. In this way, the number of CSI-RS ports of one polarization for the ith TRP is

$$\frac{1}{2} {P}_{CSI - RS , i} .$$

The UE 502 may report a selection value indicating how to select Lᵢ ports from the

$$\frac{1}{2} {P}_{CSI - RS , i}$$

CSI-RS ports of single polarization for TRP i, i=1~M_{TRP}. The selection value may be expressed by

$$⌈ {log}_{2} ( \begin{matrix}\frac{1}{2} {P}_{CSI - RS , i} \\ 2 {L}_{i}\end{matrix} ) ⌉$$

bits.

In some aspects, the network node 504 may configures the total number of UE-selected CSI-RS ports in all TRPs Lₜₒₜₐₗ, and the UE 502 may determine and report an indication of how the Lₜₒₜₐₗ ports are allocated to each TRP. For example, in some aspects, the UE 502 may report the number of selected CSI-RS ports Lᵢ such that

$${\sum }_{i = 1}^{{M}_{T R P}} {L}_{i} \leq {L}_{total} .$$

The UE 502 may report a selection value indicating how to select Lᵢ ports from the

$$\frac{1}{2} {P}_{CSI - RS , i}$$

CSI-RS ports of single polarization of TRP i,i=1~M_{TRP}. The selection value may be expressed by

$$⌈ {log}_{2} ( \begin{matrix}\frac{1}{2} {P}_{CSI - RS , i} \\ {L}_{i}\end{matrix} ) ⌉$$

bits. The value of P_{CSI-RS,i} may be configured by the network node 504. In some aspects, the UE 502 may report a selection value indicating how to select Lₜₒₜₐₗ ports from the

$$\frac{1}{2} {P}_{CSI - RS , total}$$

CSI-RS ports. The selection value may be expressed by

$$⌈ {log}_{2} ( \begin{matrix}\frac{1}{2} {P}_{CSI - RS , total} \\ {L}_{total}\end{matrix} ) ⌉$$

bits. The value of P_{CSI-RS,total} may be configured by the network node 504. Because the association between TRPs and CSI-RS ports may be known by the network node 504, the network node 504 may be aware of

$${\{ {L}_{i} \}}_{i = 1}^{{M}_{T R P}}$$

implicitly based on the reported selection result.

In some aspects, the configuration information may indicate a quantity of NZCs associated with the plurality of TRPs. For example, the configuration information may indicate the quantity of NZCs based on indicating coefficient indication values K_{0,i} associated with respective TRPs of the plurality of TRPs. The NZC information may indicate, based on the coefficient indication values, a position associated with each NZC associated with the plurality of TRPs. In some aspects, for example, the network node 504 may configure K_{0,i} for each single TRP i, i=1~M_{TRP}. The UE 502 may report the positions of NZCs of all TRPs based on K_{0,i}. The number of NZCs of TRP i in one layer should be less than or equal to K_{0,i}, and the number of NZCs of TRP i in all layers should be less than or equal to 2K_{0,i}.

In some examples, the network node 504 may configure a common a and a common β for all of the TRPs. The UE 502 may calculate K_{1,i}=αP_{CSI-RSi}, K_{0,i}=[βK_{1,i}Mᵢ]. If the configuration information and/or a wireless communication standard indicates Mᵢ=M,∇i, then K_{0,i}=BK_{1,i}M. If P_{CSI-RS,i} is identical for all TRPs, K_{1,i} and K_{0,i} are also identical for all TRPs. Additionally,

$${K}_{l , i}^{N Z} and {K}_{i}^{N Z}$$

may be based on K_{0,i} for each TRP i,i=1~M_{TRP}. In some other examples, the network node 504 may configure an individual αᵢ and/or an individual βᵢ for each TRP i,i=1~M_{TRP}. The UE 502 may derive

$${K}_{1 , i} , {K}_{0 , i} , {K}_{l , i}^{N Z} and {K}_{i}^{N Z}$$

based on the above formulas.

In some aspects, the configuration information may indicate the quantity of NZCs based on indicating a total coefficient indication value K_{0,total} associated with the plurality of TRPs. The NZC information may indicate, based on the total coefficient indication value, a position associated with each TRP of the plurality of TRPs. For example, in some aspects, the network node 504 may configure K_{0,total} for all TRPs, and the UE 502 may report the positions of NZCs of all TRPs based on K_{0,total}. In some aspects, the total number of NZCs of all TRPs in one layer may be less than or equal to K_{0,total}, and the number of NZCs of all TRPs in all layers should be less than or equal to 2K_{0,total}. In some examples, the network node 504 may configure one a and one β for all of the TRPs. The configuration information and/or a wireless communication standard may indicate Mᵢ=M,∇i. In those examples, K1=αP_{CSI-RS,total}, K_{0,total}=┌βK₁M┐, where P_{CSI-RS,total} is total number of CSI-RS ports for all TRPs. In some other examples, the network node 504 may configure individual αᵢ, Bᵢ, Mᵢ and/or P_{CSI-RS,i}, which results in different TRPs having different K_{0,i} values based on K_{1,i}=αᵢP_{CSI-RS,i}, K_{0,i}=┌βᵢK_{1,i}Mᵢ┐. In those examples,

$${K}_{0 , total} = {\sum }_{i = 1}^{{M}_{T R P}} {K}_{0 , i} .$$

FIG. 6 is a flowchart illustrating an example process 600 performed, for example, by a UE that supports CSI reporting in accordance with the present disclosure. Example process 600 is an example where the UE (for example, UE 502) performs operations associated with mTRP CJT CSI reporting.

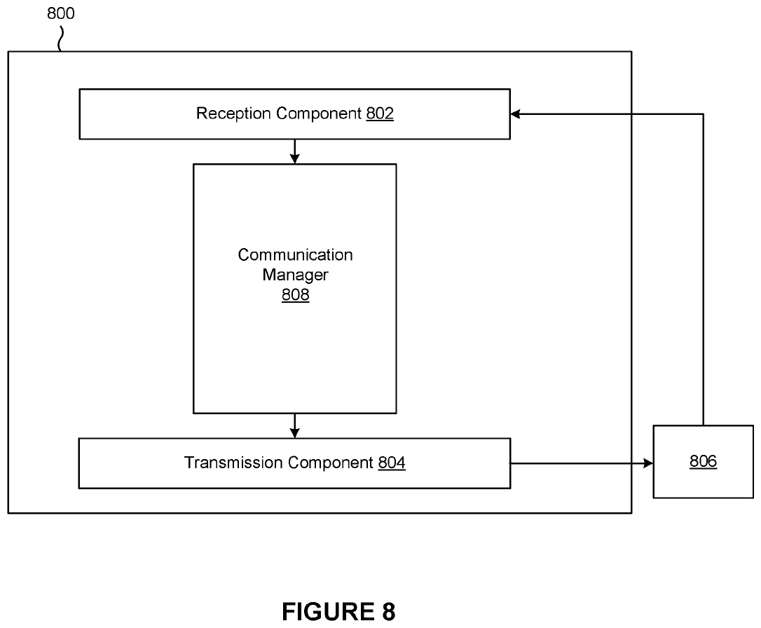

As shown in FIG. 6, in some aspects, process 600 may include receiving configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook (block 610). For example, the UE (such as by using communication manager 808 or reception component 802, depicted in FIG. 8) may receive configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook, as described above.

As further shown in FIG. 6, in some aspects, process 600 may include receiving a plurality of precoded CSI-RSs from the plurality of TRPs, wherein each of the plurality of precoded CSI-RSs is based on an SD precoding operation and an FD precoding operation (block 620). For example, the UE (such as by using communication manager 808 or reception component 802, depicted in FIG. 8) may receive a plurality of precoded CSI-RSs from the plurality of TRPs, wherein each of the plurality of precoded CSI-RSs is based on an SD precoding operation and an FD precoding operation, as described above.

As further shown in FIG. 6, in some aspects, process 600 may include transmitting a reporting communication based on the configuration information and the plurality of precoded CSI-RSs (block 630). For example, the UE (such as by using communication manager 808 or transmission component 804, depicted in FIG. 8) may transmit a reporting communication based on the configuration information and the plurality of precoded CSI-RSs, as described above.

Process 600 may include additional aspects, such as any single aspect or any combination of aspects described below or in connection with one or more other processes described elsewhere herein.

In a first additional aspect, the reporting communication comprises an mTRP CJT CSI report including a further enhanced (Fe) Type-II port selection codebook. In a second additional aspect, alone or in combination with the first aspect, the FD precoding operation is associated with an FD precoding mode associated with at least one path delay difference associated with at least one TRP of the plurality of TRPs, and the reporting communication indicates the FD basis information, wherein the FD basis information is based on the FD precoding mode.

In a third additional aspect, alone or in combination with one or more of the first and second aspects, the FD basis information indicates, based on the FD precoding mode comprising a mode in which an FD precoding weight associated with a respective TRP of the plurality of TRPs is based on a respective path delay difference associated with the respective TRP a TRP index associated with a first TRP, of the plurality of TRPs, associated with an FD basis window having a start position associated with an FD basis 0, and a plurality of FD basis window positions associated with respective TRPs of the plurality of TRPs other than the first TRP. In a fourth additional aspect, alone or in combination with one or more of the first through third aspects, the FD basis information indicates, based on the FD precoding mode comprising a mode in which an FD precoding weight associated with a respective TRP of the plurality of TRPs is associated with a plurality of path delay differences associated with respective TRPs of a set of two or more TRPs of the plurality of TRPs an FD basis window position associated with the set of two or more TRPs, and a respective FD basis window position associated with each TRP of the plurality of TRPs not included in the set of two or more TRPs. In a fifth additional aspect, alone or in combination with one or more of the first through fourth aspects, each FD basis window position associated with the plurality of TRPs corresponds to an FD basis 0 start position based on the FD precoding mode comprising a mode in which an FD precoding weight associated with a respective TRP of the plurality of TRPs is associated with a plurality of path delay differences, each of which is associated with a respective TRP of the plurality of TRPs. In a sixth additional aspect, alone or in combination with one or more of the first through fifth aspects, the FD basis information includes a plurality of selected FD bases associated with a plurality of FD basis windows, wherein each FD basis window of the plurality of FD basis windows is associated with a respective TRP of the plurality of TRPs.

In a seventh additional aspect, alone or in combination with one or more of the first through sixth aspects, a single FD basis window length is common to each FD basis window of the plurality of FD basis windows. In an eighth additional aspect, alone or in combination with one or more of the first through seventh aspects, each FD basis window of the plurality of FD basis windows has a respective length associated with the respective TRP. In a ninth additional aspect, alone or in combination with one or more of the first through eighth aspects, the FD basis information includes a plurality of selected FD bases respectively associated with the plurality of TRPs, and process 600 includes obtaining an indication of one or more FD basis parameters associated with the plurality of selected FD bases.

In a tenth additional aspect, alone or in combination with one or more of the first through ninth aspects, the configuration information includes the indication of the one or more FD basis parameters. In an eleventh additional aspect, alone or in combination with one or more of the first through tenth aspects, obtaining the indication of the FD basis parameter comprises accessing a memory associated with the UE, wherein the indication of the one or more FD basis parameters is stored in the memory. In a twelfth additional aspect, alone or in combination with one or more of the first through eleventh aspects, the one or more FD basis parameters indicate a quantity of selected FD bases common to all of the TRPs of the plurality of TRPs. In a thirteenth additional aspect, alone or in combination with one or more of the first through twelfth aspects, the one or more FD basis parameters indicate a quantity of selected FD bases associated with each TRP of the plurality of TRPs. In a fourteenth additional aspect, alone or in combination with one or more of the first through thirteenth aspects, the one or more FD basis parameters indicate a maximum quantity of selected FD bases associated with a TRP of the plurality of TRPs. In a fifteenth additional aspect, alone or in combination with one or more of the first through fourteenth aspects, the FD basis information indicates a quantity of selected FD bases associated with each TRP of the plurality of TRPs. In a sixteenth additional aspect, alone or in combination with one or more of the first through fifteenth aspects, the one or more FD basis parameters indicate a maximum quantity of selected FD bases associated with the plurality of TRPs.

In a seventeenth additional aspect, alone or in combination with one or more of the first through sixteenth aspects, the FD basis information indicates at least one FD basis associated with a TRP of the plurality of TRPs, and the at least one FD basis is based on an FD basis window start position associated with an FD basis window, an FD basis window length associated with the FD basis window, and a quantity of selected FD bases associated with the TRP. In an eighteenth additional aspect, alone or in combination with one or more of the first through seventeenth aspects, the at least one FD basis comprises a first FD basis occurring in the FD basis window after the FD basis window start position. In a nineteenth additional aspect, alone or in combination with one or more of the first through eighteenth aspects, the FD basis information indicates the FD basis selection based on the at least one FD basis including two or more FD bases. In a twentieth additional aspect, alone or in combination with one or more of the first through nineteenth aspects, the FD basis information indicates a respective FD basis index associated with each of the two or more FD bases other than a first FD basis occurring in the FD basis window after the FD basis window start position.

In a twenty-first additional aspect, alone or in combination with one or more of the first through twentieth aspects, the configuration information indicates a total quantity of UE-selected CSI-RS ports associated with the plurality of TRPs, and the SD basis information indicates a selection value associated with selection of one or more CSI-RS ports associated with a TRP of the plurality of TRPs. In a twenty-second additional aspect, alone or in combination with one or more of the first through twenty-first aspects, the configuration information indicates quantities of selectable CSI-RS ports associated with respective TRPs of the plurality of TRPs. In a twenty-third additional aspect, alone or in combination with one or more of the first through twenty-second aspects, the configuration information indicates CSI-RS resources associated with respective TRPs of the plurality of TRPs, and quantities of selectable CSI-RS ports associated with respective TRPs of the plurality of TRPs are indicated by respective port quantity values. In a twenty-fourth additional aspect, alone or in combination with one or more of the first through twenty-third aspects, the configuration information indicates CSI-RS resources associated with respective TRPs of the plurality of TRPs, and quantities of selectable CSI-RS ports associated with respective TRPs of the plurality of TRPs are based on a port quantity value common to the plurality of TRPs. In a twenty-fifth additional aspect, alone or in combination with one or more of the first through twenty-fourth aspects, the configuration information indicates quantities of ineffective ports associated with respective TRPs of the plurality of TRPs, and the quantities of selectable CSI-RS ports associated with respective TRPs are based on the port quantity value and the respective quantities of ineffective ports.

In a twenty-sixth additional aspect, alone or in combination with one or more of the first through twenty-fifth aspects, the configuration information indicates a quantity of UE-selected CSI-RS ports associated with each TRP of the plurality of TRPs, and the SD basis information indicates a selection value associated with selection of one or more CSI-RS ports associated with each TRP of the plurality of TRPs. In a twenty-seventh additional aspect, alone or in combination with one or more of the first through twenty-sixth aspects, the configuration information indicates a total quantity of UE-selected CSI-RS ports associated with the plurality of TRPs, and the SD basis information indicates selection information associated with an allocation of the total quantity of UE-selected CSI-RS ports across the plurality of TRPs. In a twenty-eighth additional aspect, alone or in combination with one or more of the first through twenty-seventh aspects, the selection information indicates a quantity of selected CSI-RS ports. In a twenty-ninth additional aspect, alone or in combination with one or more of the first through twenty-eighth aspects, the selection information indicates a selection value associated with selection of a set of selected CSI-RS ports from among a set of CSI-RS ports associated with the plurality of TRPs.

In a thirtieth additional aspect, alone or in combination with one or more of the first through twenty-ninth aspects, the configuration information indicates a quantity of NZCs associated with the plurality of TRPs. In a thirty-first additional aspect, alone or in combination with one or more of the first through thirtieth aspects, the configuration information indicates the quantity of NZCs based on indicating coefficient indication values associated with respective TRPs of the plurality of TRPs, wherein the NZC information indicates, based on the coefficient indication values, a position associated with each NZC associated with the plurality of TRPs. In a thirty-second additional aspect, alone or in combination with one or more of the first through thirty-first aspects, the configuration information indicates the quantity of NZCs based on indicating a total coefficient indication value associated with the plurality of TRPs, wherein the NZC information further indicates, based on the total coefficient indication value, a position associated with each TRP of the plurality of TRPs.

In a thirty-third additional aspect, alone or in combination with one or more of the first through thirty-second aspects, process 600 includes receiving a sounding reference signal (SRS) configuration associated with at least one channel estimation of at least one uplink channel between the UE and at least one TRP of the plurality of TRPs, and transmitting the SRS based on the SRS configuration, wherein the plurality of precoded CSI-RSs is associated with a set of SD precoding weights and a set of FD precoding weights, wherein each of the set of SD precoding weights and the set of FD precoding weights is based on the at least one channel estimation. In a thirty-fourth additional aspect, alone or in combination with one or more of the first through thirty-third aspects, an FD precoding weight, associated with a TRP of the plurality of TRPs, of the set of FD precoding weights is based on a path delay associated with the TRP. In a thirty-fifth additional aspect, alone or in combination with one or more of the first through thirty-fourth aspects, an FD precoding weight, associated with a TRP of the plurality of TRPs, of the set of FD precoding weights is based on a plurality of path delays associated with two or more TRPs of the plurality of TRPs. In a thirty-sixth additional aspect, alone or in combination with one or more of the first through thirty-fifth aspects, a CSI-RS of the plurality of precoded CSI-RSs is associated with a dominant path associated with a TRP of the plurality of TRPs and is based on an FD precoding weight of the set of FD precoding weights.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, by a network node that supports CSI reporting in accordance with the present disclosure. Example process 700 is an example where the network node (for example, network node 504) performs operations associated with mTRP CJT CSI reporting.

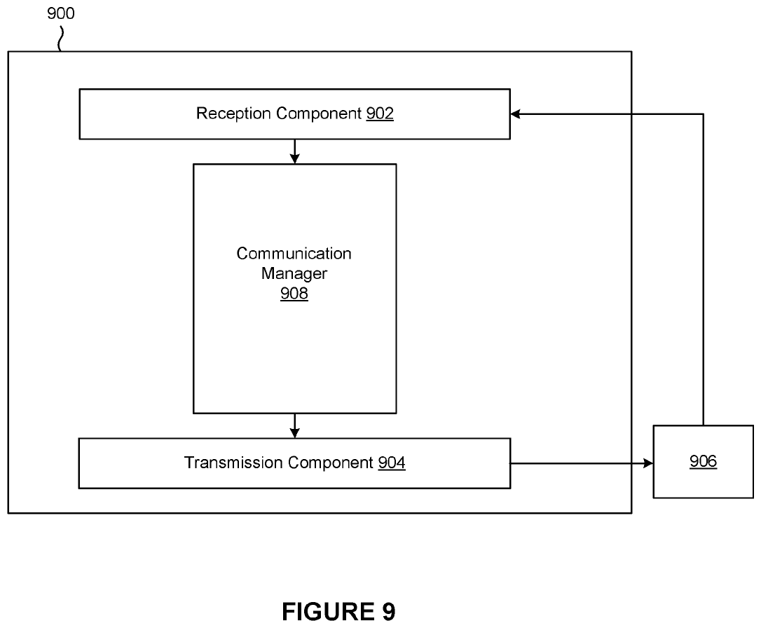

As shown in FIG. 7, in some aspects, process 700 may include transmitting configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook (block 710). For example, the network node (such as by using communication manager 908 or transmission component 904, depicted in FIG. 9) may transmit configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook, as described above.

As further shown in FIG. 7, in some aspects, process 700 may include transmitting a plurality of precoded CSI-RSs from the plurality of TRPs, wherein each of the plurality of precoded CSI-RSs is based on an SD precoding operation and an FD precoding operation (block 720). For example, the network node (such as by using communication manager 908 or transmission component 904, depicted in FIG. 9) may transmit a plurality of precoded CSI-RSs from the plurality of TRPs, wherein each of the plurality of precoded CSI-RSs is based on an SD precoding operation and an FD precoding operation, as described above.

As further shown in FIG. 7, in some aspects, process 700 may include receiving a reporting communication based on the configuration information and the plurality of precoded CSI-RSs (block 730). For example, the network node (such as by using communication manager 908 or reception component 902, depicted in FIG. 9) may receive a reporting communication based on the configuration information and the plurality of precoded CSI-RSs, as described above.

Process 700 may include additional aspects, such as any single aspect or any combination of aspects described below or in connection with one or more other processes described elsewhere herein.

In a first additional aspect, the reporting communication comprises an mTRP CJT CSI report including a further enhanced (Fe) Type-II port selection codebook. In a second additional aspect, alone or in combination with the first aspect, the FD precoding operation is associated with an FD precoding mode associated with at least one path delay difference associated with at least one TRP of the plurality of TRPs, and the reporting communication indicates the FD basis information, wherein the FD basis information is based on the FD precoding mode.

In a third additional aspect, alone or in combination with one or more of the first and second aspects, the FD basis information indicates, based on the FD precoding mode comprising a mode in which an FD precoding weight associated with a respective TRP of the plurality of TRPs is based on a respective path delay difference associated with the respective TRP a TRP index associated with a first TRP, of the plurality of TRPs, associated with an FD basis window having a start position associated with an FD basis 0, and a plurality of FD basis window positions associated with respective TRPs of the plurality of TRPs other than the first TRP. In a fourth additional aspect, alone or in combination with one or more of the first through third aspects, the FD basis information indicates, based on the FD precoding mode comprising a mode in which an FD precoding weight associated with a respective TRP of the plurality of TRPs is associated with a plurality of path delay differences associated with respective TRPs of a set of two or more TRPs of the plurality of TRPs an FD basis window position associated with the set of two or more TRPs, and a respective FD basis window position associated with each TRP of the plurality of TRPs not included in the set of two or more TRPs. In a fifth additional aspect, alone or in combination with one or more of the first through fourth aspects, each FD basis window position associated with the plurality of TRPs corresponds to an FD basis 0 start position based on the FD precoding mode comprising a mode in which an FD precoding weight associated with a respective TRP of the plurality of TRPs is associated with a plurality of path delay differences, each of which is associated with a respective TRP of the plurality of TRPs.

In a sixth additional aspect, alone or in combination with one or more of the first through fifth aspects, the FD basis information includes a plurality of selected FD bases associated with a plurality of FD basis windows, wherein each FD basis window of the plurality of FD basis windows is associated with a respective TRP of the plurality of TRPs. In a seventh additional aspect, alone or in combination with one or more of the first through sixth aspects, a single FD basis window length is common to each FD basis window of the plurality of FD basis windows. In an eighth additional aspect, alone or in combination with one or more of the first through seventh aspects, each FD basis window of the plurality of FD basis windows has a respective length associated with the respective TRP.

In a ninth additional aspect, alone or in combination with one or more of the first through eighth aspects, the FD basis information includes a plurality of selected FD bases respectively associated with the plurality of TRPs, wherein one or more FD basis parameters are associated with the plurality of selected FD bases. In a tenth additional aspect, alone or in combination with one or more of the first through ninth aspects, the configuration information includes an indication of the one or more FD basis parameters. In an eleventh additional aspect, alone or in combination with one or more of the first through tenth aspects, the one or more FD basis parameters indicate a quantity of selected FD bases common to all of the TRPs of the plurality of TRPs. In a twelfth additional aspect, alone or in combination with one or more of the first through eleventh aspects, the one or more FD basis parameters indicate a quantity of selected FD bases associated with each TRP of the plurality of TRPs. In a thirteenth additional aspect, alone or in combination with one or more of the first through twelfth aspects, the one or more FD basis parameters indicate a maximum quantity of selected FD bases associated with a TRP of the plurality of TRPs.

In a fourteenth additional aspect, alone or in combination with one or more of the first through thirteenth aspects, the FD basis information indicates a quantity of selected FD bases associated with each TRP of the plurality of TRPs. In a fifteenth additional aspect, alone or in combination with one or more of the first through fourteenth aspects, the one or more FD basis parameters indicate a maximum quantity of selected FD bases associated with the plurality of TRPs. In a sixteenth additional aspect, alone or in combination with one or more of the first through fifteenth aspects, the FD basis information indicates at least one FD basis associated with a TRP of the plurality of TRPs, and the at least one FD basis is based on an FD basis window start position associated with an FD basis window, an FD basis window length associated with the FD basis window, and a quantity of selected FD bases associated with the TRP. In a seventeenth additional aspect, alone or in combination with one or more of the first through sixteenth aspects, the at least one FD basis comprises a first FD basis occurring in the FD basis window after the FD basis window start position. In an eighteenth additional aspect, alone or in combination with one or more of the first through seventeenth aspects, the FD basis information indicates the FD basis selection based on the at least one FD basis including two or more FD bases. In a nineteenth additional aspect, alone or in combination with one or more of the first through eighteenth aspects, the FD basis information indicates a respective FD basis index associated with each of the two or more FD bases other than a first FD basis occurring in the FD basis window after the FD basis window start position.

In a twentieth additional aspect, alone or in combination with one or more of the first through nineteenth aspects, the configuration information indicates a total quantity of UE-selected CSI-RS ports associated with the plurality of TRPs, and the SD basis information indicates a selection value associated with selection of one or more CSI-RS ports associated with a TRP of the plurality of TRPs. In a twenty-first additional aspect, alone or in combination with one or more of the first through twentieth aspects, the configuration information indicates quantities of selectable CSI-RS ports associated with respective TRPs of the plurality of TRPs. In a twenty-second additional aspect, alone or in combination with one or more of the first through twenty-first aspects, the configuration information indicates CSI-RS resources associated with respective TRPs of the plurality of TRPs, and quantities of selectable CSI-RS ports associated with respective TRPs of the plurality of TRPs are indicated by respective port quantity values. In a twenty-third additional aspect, alone or in combination with one or more of the first through twenty-second aspects, the configuration information indicates CSI-RS resources associated with respective TRPs of the plurality of TRPs, and quantities of selectable CSI-RS ports associated with respective TRPs of the plurality of TRPs are based on a port quantity value common to the plurality of TRPs. In a twenty-fourth additional aspect, alone or in combination with one or more of the first through twenty-third aspects, the configuration information indicates quantities of ineffective ports associated with respective TRPs of the plurality of TRPs, and the quantities of selectable CSI-RS ports associated with respective TRPs are based on the port quantity value and the respective quantities of ineffective ports.

In a twenty-fifth additional aspect, alone or in combination with one or more of the first through twenty-fourth aspects, the configuration information indicates a quantity of UE-selected CSI-RS ports associated with each TRP of the plurality of TRPs, and the SD basis information indicates a selection value associated with selection of one or more CSI-RS ports associated with each TRP of the plurality of TRPs. In a twenty-sixth additional aspect, alone or in combination with one or more of the first through twenty-fifth aspects, the configuration information indicates a total quantity of UE-selected CSI-RS ports associated with the plurality of TRPs, and the SD basis information indicates selection information associated with an allocation of the total quantity of UE-selected CSI-RS ports across the plurality of TRPs. In a twenty-seventh additional aspect, alone or in combination with one or more of the first through twenty-sixth aspects, the selection information indicates a quantity of selected CSI-RS ports. In a twenty-eighth additional aspect, alone or in combination with one or more of the first through twenty-seventh aspects, the selection information indicates a selection value associated with selection of a set of selected CSI-RS ports from among a set of CSI-RS ports associated with the plurality of TRPs.

In a twenty-ninth additional aspect, alone or in combination with one or more of the first through twenty-eighth aspects, the configuration information indicates a quantity of NZCs associated with the plurality of TRPs. In a thirtieth additional aspect, alone or in combination with one or more of the first through twenty-ninth aspects, the configuration information indicates the quantity of NZCs based on indicating coefficient indication values associated with respective TRPs of the plurality of TRPs, wherein the NZC information indicates, based on the coefficient indication values, a position associated with each NZC associated with the plurality of TRPs. In a thirty-first additional aspect, alone or in combination with one or more of the first through thirtieth aspects, the configuration information indicates the quantity of NZCs based on indicating a total coefficient indication value associated with the plurality of TRPs, wherein the NZC information further indicates, based on the total coefficient indication value, a position associated with each TRP of the plurality of TRPs.

In a thirty-second additional aspect, alone or in combination with one or more of the first through thirty-first aspects, process 700 includes transmitting a sounding reference signal (SRS) configuration associated with at least one channel estimation of at least one uplink channel between a UE and at least one TRP of the plurality of TRPs, and receiving the SRS based on the SRS configuration, wherein the plurality of precoded CSI-RSs is associated with a set of SD precoding weights and a set of FD precoding weights, wherein each of the set of SD precoding weights and the set of FD precoding weights is based on the at least one channel estimation. In a thirty-third additional aspect, alone or in combination with one or more of the first through thirty-second aspects, an FD precoding weight, associated with a TRP of the plurality of TRPs, of the set of FD precoding weights is based on a path delay associated with the TRP. In a thirty-fourth additional aspect, alone or in combination with one or more of the first through thirty-third aspects, an FD precoding weight, associated with a TRP of the plurality of TRPs, of the set of FD precoding weights is based on a plurality of path delays associated with two or more TRPs of the plurality of TRPs. In a thirty-fifth additional aspect, alone or in combination with one or more of the first through thirty-fourth aspects, a CSI-RS of the plurality of precoded CSI-RSs is associated with a dominant path associated with a TRP of the plurality of TRPs and is based on an FD precoding weight of the set of FD precoding weights.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports CSI reporting in accordance with the present disclosure. The apparatus 800 may be a UE, or a UE may include the apparatus 800. In some aspects, the apparatus 800 includes a reception component 802, a transmission component 804, and a communication manager 808, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to perform one or more operations described herein in connection with FIG. 5. Additionally or alternatively, the apparatus 800 may be configured to perform one or more processes described herein, such as process 600 of FIG. 6. In some aspects, the apparatus 800 may include one or more components of the UE described above in connection with FIG. 2.

The reception component 802 may receive communications, such as reference signals, control information, and/or data communications, from the apparatus 806. The reception component 802 may provide received communications to one or more other components of the apparatus 800, such as the communication manager 808. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, a modem, a demodulator, a MIMO detector, a receive processor, a controller/processor, and/or a memory of the UE described above in connection with FIG. 2.

The transmission component 804 may transmit communications, such as reference signals, control information, and/or data communications, to the apparatus 906. In some aspects, the communication manager 808 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, and/or a memory of the UE described above in connection with FIG. 2. In some aspects, the transmission component 804 may be co-located with the reception component 802 in a transceiver.

The communication manager 808 may receive or may cause the reception component 802 to receive configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The communication manager 808 may receive or may cause the reception component 802 to receive a plurality of precoded CSI-RSs from the plurality of TRPs, wherein each of the plurality of precoded CSI-RSs is based on an SD precoding operation and an FD precoding operation. The communication manager 808 may transmit or may cause the transmission component 804 to transmit a reporting communication based on the configuration information and the plurality of precoded CSI-RSs. In some aspects, the communication manager 808 may perform one or more operations described elsewhere herein as being performed by one or more components of the communication manager 808.

The communication manager 808 may include a controller/processor, and/or a memory, of the UE described above in connection with FIG. 2. In some aspects, the communication manager 808 includes a set of components. Alternatively, the set of components may be separate and distinct from the communication manager 808. In some aspects, one or more components of the set of components may include or may be implemented within a controller/processor, and/or a memory of the UE described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component. In some aspects, the communication manager 808 may be, be similar to, include, or be included in, the communication manager 140 described in connection with FIGS. 1 and 2.

The reception component 802 may receive configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The reception component 802 may receive a plurality of precoded CSI-RSs from the plurality of TRPs, wherein each of the plurality of precoded CSI-RSs is based on an SD precoding operation and an FD precoding operation. The transmission component 804 may transmit a reporting communication based on the configuration information and the plurality of precoded CSI-RSs.

The reception component 802 may receive a sounding reference signal (SRS) configuration associated with at least one channel estimation of at least one uplink channel between the UE and at least one TRP of the plurality of TRPs. The transmission component 804 may transmit the SRS based on the SRS configuration, wherein the plurality of precoded CSI-RSs is associated with a set of SD precoding weights and a set of FD precoding weights, wherein each of the set of SD precoding weights and the set of FD precoding weights is based on the at least one channel estimation.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports CSI reporting in accordance with the present disclosure. The apparatus 900 may be a network node, or a network node may include the apparatus 900. In some aspects, the apparatus 900 includes a reception component 902, a transmission component 904, and a communication manager 908, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to perform one or more operations described herein in connection with FIG. 5. Additionally or alternatively, the apparatus 900 may be configured to perform one or more processes described herein, such as process 700 of FIG. 7. In some aspects, the apparatus 900 may include one or more components of the network node described above in connection with FIG. 2.

The reception component 902 may receive communications, such as reference signals, control information, and/or data communications, from the apparatus 906. The reception component 902 may provide received communications to one or more other components of the apparatus 900, such as the communication manager 908. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, a modem, a demodulator, a MIMO detector, a receive processor, a controller/processor, and/or a memory of the network node described above in connection with FIG. 2.

The transmission component 904 may transmit communications, such as reference signals, control information, and/or data communications, to the apparatus 906. In some aspects, the communication manager 908 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, and/or a memory of the network node described above in connection with FIG. 2. In some aspects, the transmission component 904 may be co-located with the reception component 902 in a transceiver.

The communication manager 908 may transmit or may cause the transmission component 904 to transmit configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The communication manager 908 may transmit or may cause the transmission component 904 to transmit a plurality of precoded CSI-RSs from the plurality of TRPs, wherein each of the plurality of precoded CSI-RSs is based on an SD precoding operation and an FD precoding operation. The communication manager 908 may receive or may cause the reception component 902 to receive a reporting communication based on the configuration information and the plurality of precoded CSI-RSs. In some aspects, the communication manager 908 may perform one or more operations described elsewhere herein as being performed by one or more components of the communication manager 908.

The communication manager 908 may include a controller/processor, a memory, a scheduler, and/or a communication unit of the network node described above in connection with FIG. 2. In some aspects, the communication manager 908 includes a set of components. Alternatively, the set of components may be separate and distinct from the communication manager 908. In some aspects, one or more components of the set of components may include or may be implemented within a controller/processor, a memory, a scheduler, and/or a communication unit of the network node described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component. In some aspects, the communication manager 908 may be, be similar to, include, or be included in, the communication manager 150 described in connection with FIGS. 1 and 2.

The transmission component 904 may transmit configuration information associated with reporting CSI associated with a plurality of TRPs for mTRP CJT, the CSI including, for each of the plurality of TRPs, FD basis information associated with a port selection codebook, SD basis information associated with the port selection codebook, and NZC information associated with the port selection codebook. The transmission component 904 may transmit a plurality of precoded CSI-RSs from the plurality of TRPs, wherein each of the plurality of precoded CSI-RSs is based on an SD precoding operation and an FD precoding operation. The reception component 902 may receive a reporting communication based on the configuration information and the plurality of precoded CSI-RSs.

The transmission component 904 may transmit a sounding reference signal (SRS) configuration associated with at least one channel estimation of at least one uplink channel between a UE and at least one TRP of the plurality of TRPs. The reception component 902 may receive the SRS based on the SRS configuration, wherein the plurality of precoded CSI-RSs is associated with a set of SD precoding weights and a set of FD precoding weights, wherein each of the set of SD precoding weights and the set of FD precoding weights is based on the at least one channel estimation.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by an apparatus at a user equipment (UE), comprising: receiving configuration information associated with reporting channel state information (CSI) associated with a plurality of transmission reception points (TRPs) for multiple TRP (mTRP) coherent joint transmission (CJT), the CSI including, for each of the plurality of TRPs, frequency domain (FD) basis information associated with a port selection codebook, spatial domain (SD) basis information associated with the port selection codebook, and non-zero coefficient (NZC) information associated with the port selection codebook; receiving a plurality of precoded channel state information (CSI)-reference signals (CSI-RSs) from the plurality of TRPs, wherein each of the plurality of precoded CSI-RSs is based on an SD precoding operation and an FD precoding operation; and transmitting a reporting communication based on the configuration information and the plurality of precoded CSI-RSs.

Aspect 2: The method of Aspect 1, wherein the reporting communication comprises an mTRP CJT CSI report including a further enhanced (Fe) Type-II port selection codebook.

Aspect 3: The method of either of claim 1 or 2, wherein the FD precoding operation is associated with an FD precoding mode associated with at least one path delay difference associated with at least one TRP of the plurality of TRPs, and wherein the reporting communication indicates the FD basis information, wherein the FD basis information is based on the FD precoding mode.

Aspect 4: The method of Aspect 3, wherein the FD basis information indicates, based on the FD precoding mode comprising a mode in which an FD precoding weight associated with a respective TRP of the plurality of TRPs is based on a respective path delay difference associated with the respective TRP: a TRP index associated with a first TRP, of the plurality of TRPs, associated with an FD basis window having a start position associated with an FD basis 0, and a plurality of FD basis window positions associated with respective TRPs of the plurality of TRPs other than the first TRP. a TRP index associated with a first TRP, of the plurality of TRPs, associated with an FD basis window having a start position associated with an FD basis 0, and a plurality of FD basis window positions associated with respective TRPs of the plurality of TRPs other than the first TRP.

Aspect 5: The method of Aspect 3, wherein the FD basis information indicates, based on the FD precoding mode comprising a mode in which an FD precoding weight associated with a respective TRP of the plurality of TRPs is associated with a plurality of path delay differences associated with respective TRPs of a set of two or more TRPs of the plurality of TRPs: an FD basis window position associated with the set of two or more TRPs, and a respective FD basis window position associated with each TRP of the plurality of TRPs not included in the set of two or more TRPs. an FD basis window position associated with the set of two or more TRPs, and a respective FD basis window position associated with each TRP of the plurality of TRPs not included in the set of two or more TRPs.

Aspect 6: The method of Aspect 3, wherein each FD basis window position associated with the plurality of TRPs corresponds to an FD basis 0 start position based on the FD precoding mode comprising a mode in which an FD precoding weight associated with a respective TRP of the plurality of TRPs is associated with a plurality of path delay differences, each of which is associated with a respective TRP of the plurality of TRPs.

Aspect 7: The method of any of Aspects 1-6, wherein the FD basis information includes a plurality of selected FD bases associated with a plurality of FD basis windows, wherein each FD basis window of the plurality of FD basis windows is associated with a respective TRP of the plurality of TRPs.

Aspect 8: The method of Aspect 7, wherein a single FD basis window length is common to each FD basis window of the plurality of FD basis windows.

Aspect 9: The method of any of Aspects 7-8, wherein each FD basis window of the plurality of FD basis windows has a respective length associated with the respective TRP.

Aspect 10: The method of any of Aspects 1-9, wherein the FD basis information includes a plurality of selected FD bases respectively associated with the plurality of TRPs, the method further comprising obtaining an indication of one or more FD basis parameters associated with the plurality of selected FD bases.

Aspect 11: The method of Aspect 10, wherein the configuration information includes the indication of the one or more FD basis parameters.

Aspect 12: The method of either of claim 10 or 11, wherein obtaining the indication of the FD basis parameter comprises accessing a memory associated with the UE, wherein the indication of the one or more FD basis parameters is stored in the memory.

Aspect 13: The method of any of Aspects 10-12, wherein the one or more FD basis parameters indicate a quantity of selected FD bases common to all of the TRPs of the plurality of TRPs.

Aspect 14: The method of any of Aspects 10-12, wherein the one or more FD basis parameters indicate a quantity of selected FD bases associated with each TRP of the plurality of TRPs.

Aspect 15: The method of any of Aspects 10-14, wherein the one or more FD basis parameters indicate a maximum quantity of selected FD bases associated with a TRP of the plurality of TRPs.

Aspect 16: The method of Aspect 15, wherein the FD basis information indicates a quantity of selected FD bases associated with each TRP of the plurality of TRPs.

Aspect 17: The method of any of Aspects 10-14, wherein the one or more FD basis parameters indicate a maximum quantity of selected FD bases associated with the plurality of TRPs.

Aspect 18: The method of any of Aspects 1-17, wherein the FD basis information indicates at least one FD basis associated with a TRP of the plurality of TRPs, and wherein the at least one FD basis is based on an FD basis window start position associated with an FD basis window, an FD basis window length associated with the FD basis window, and a quantity of selected FD bases associated with the TRP.

Aspect 19: The method of Aspect 18, wherein the at least one FD basis comprises a first FD basis occurring in the FD basis window after the FD basis window start position.

Aspect 20: The method of either of claim 18 or 19, wherein the FD basis information indicates the FD basis selection based on the at least one FD basis including two or more FD bases.

Aspect 21: The method of Aspect 20, wherein the FD basis information indicates a respective FD basis index associated with each of the two or more FD bases other than a first FD basis occurring in the FD basis window after the FD basis window start position.

Aspect 22: The method of Aspect 21, wherein the configuration information indicates a total quantity of UE-selected CSI-RS ports associated with the plurality of TRPs, and wherein the SD basis information indicates a selection value associated with selection of one or more CSI-RS ports associated with a TRP of the plurality of TRPs.

Aspect 23: The method of any of Aspects 1-22, wherein the configuration information indicates quantities of selectable CSI-RS ports associated with respective TRPs of the plurality of TRPs.

Aspect 24: The method of any of Aspects 1-23, wherein the configuration information indicates CSI-RS resources associated with respective TRPs of the plurality of TRPs, and wherein quantities of selectable CSI-RS ports associated with respective TRPs of the plurality of TRPs are indicated by respective port quantity values.

Aspect 25: The method of any of Aspects 1-23, wherein the configuration information indicates CSI-RS resources associated with respective TRPs of the plurality of TRPs, and wherein quantities of selectable CSI-RS ports associated with respective TRPs of the plurality of TRPs are based on a port quantity value common to the plurality of TRPs.

Aspect 26: The method of Aspect 25, wherein the configuration information indicates quantities of ineffective ports associated with respective TRPs of the plurality of TRPs, and wherein the quantities of selectable CSI-RS ports associated with respective TRPs are based on the port quantity value and the respective quantities of ineffective ports.

Aspect 27: The method of any of Aspects 1-26, wherein the configuration information indicates a quantity of UE-selected CSI-RS ports associated with each TRP of the plurality of TRPs, and wherein the SD basis information indicates a selection value associated with selection of one or more CSI-RS ports associated with each TRP of the plurality of TRPs.

Aspect 28: The method of any of Aspects 1-26, wherein the configuration information indicates a total quantity of UE-selected CSI-RS ports associated with the plurality of TRPs, and wherein the SD basis information indicates selection information associated with an allocation of the total quantity of UE-selected CSI-RS ports across the plurality of TRPs.

Aspect 29: The method of Aspect 28, wherein the selection information indicates a quantity of selected CSI-RS ports.

Aspect 30: The method of either of claim 28 or 29, wherein the selection information indicates a selection value associated with selection of a set of selected CSI-RS ports from among a set of CSI-RS ports associated with the plurality of TRPs.

Aspect 31: The method of any of Aspects 1-30, wherein the configuration information indicates a quantity of NZCs associated with the plurality of TRPs.

Aspect 32: The method of Aspect 31, wherein the configuration information indicates the quantity of NZCs based on indicating coefficient indication values associated with respective TRPs of the plurality of TRPs, wherein the NZC information indicates, based on the coefficient indication values, a position associated with each NZC associated with the plurality of TRPs.

Aspect 33: The method of any of Aspects 31-32, wherein the configuration information indicates the quantity of NZCs based on indicating a total coefficient indication value associated with the plurality of TRPs, wherein the NZC information further indicates, based on the total coefficient indication value, a position associated with each TRP of the plurality of TRPs.

Aspect 34: The method of any of Aspects 1-33, further comprising: receiving a sounding reference signal (SRS) configuration associated with at least one channel estimation of at least one uplink channel between the UE and at least one TRP of the plurality of TRPs; and transmitting the SRS based on the SRS configuration, wherein the plurality of precoded CSI-RSs is associated with a set of SD precoding weights and a set of FD precoding weights, wherein each of the set of SD precoding weights and the set of FD precoding weights is based on the at least one channel estimation.

Aspect 35: The method of Aspect 34, wherein an FD precoding weight, associated with a TRP of the plurality of TRPs, of the set of FD precoding weights is based on a path delay associated with the TRP.

Aspect 36: The method of any of Aspects 34-35, wherein an FD precoding weight, associated with a TRP of the plurality of TRPs, of the set of FD precoding weights is based on a plurality of path delays associated with two or more TRPs of the plurality of TRPs.

Aspect 37: The method of Aspect 36, wherein a CSI-RS of the plurality of precoded CSI-RSs is associated with a dominant path associated with a TRP of the plurality of TRPs and is based on an FD precoding weight of the set of FD precoding weights.

Aspect 38: A method of wireless communication performed by an apparatus at a network node, comprising: transmitting configuration information associated with reporting channel state information (CSI) associated with a plurality of transmission reception points (TRPs) for multiple TRP (mTRP) coherent joint transmission (CJT), the CSI including, for each of the plurality of TRPs, frequency domain (FD) basis information associated with a port selection codebook, spatial domain (SD) basis information associated with the port selection codebook, and non-zero coefficient (NZC) information associated with the port selection codebook; transmitting a plurality of precoded channel state information (CSI)-reference signals (CSI-RSs) from the plurality of TRPs, wherein each of the plurality of precoded CSI-RSs is based on an SD precoding operation and an FD precoding operation; and receiving a reporting communication based on the configuration information and the plurality of precoded CSI-RSs.

Aspect 39: The method of Aspect 38, wherein the reporting communication comprises an mTRP CJT CSI report including a further enhanced (Fe) Type-II port selection codebook.

Aspect 40: The method of either of claim 38 or 39, wherein the FD precoding operation is associated with an FD precoding mode associated with at least one path delay difference associated with at least one TRP of the plurality of TRPs, and wherein the reporting communication indicates the FD basis information, wherein the FD basis information is based on the FD precoding mode.

Aspect 41: The method of Aspect 40, wherein the FD basis information indicates, based on the FD precoding mode comprising a mode in which an FD precoding weight associated with a respective TRP of the plurality of TRPs is based on a respective path delay difference associated with the respective TRP: a TRP index associated with a first TRP, of the plurality of TRPs, associated with an FD basis window having a start position associated with an FD basis 0, and a plurality of FD basis window positions associated with respective TRPs of the plurality of TRPs other than the first TRP. a TRP index associated with a first TRP, of the plurality of TRPs, associated with an FD basis window having a start position associated with an FD basis 0, and a plurality of FD basis window positions associated with respective TRPs of the plurality of TRPs other than the first TRP.

Aspect 42: The method of Aspect 40, wherein the FD basis information indicates, based on the FD precoding mode comprising a mode in which an FD precoding weight associated with a respective TRP of the plurality of TRPs is associated with a plurality of path delay differences associated with respective TRPs of a set of two or more TRPs of the plurality of TRPs: an FD basis window position associated with the set of two or more TRPs, and a respective FD basis window position associated with each TRP of the plurality of TRPs not included in the set of two or more TRPs. an FD basis window position associated with the set of two or more TRPs, and a respective FD basis window position associated with each TRP of the plurality of TRPs not included in the set of two or more TRPs.

Aspect 43: The method of Aspect 40, wherein each FD basis window position associated with the plurality of TRPs corresponds to an FD basis 0 start position based on the FD precoding mode comprising a mode in which an FD precoding weight associated with a respective TRP of the plurality of TRPs is associated with a plurality of path delay differences, each of which is associated with a respective TRP of the plurality of TRPs.

Aspect 44: The method of any of Aspects 38-43, wherein the FD basis information includes a plurality of selected FD bases associated with a plurality of FD basis windows, wherein each FD basis window of the plurality of FD basis windows is associated with a respective TRP of the plurality of TRPs.

Aspect 45: The method of Aspect 44, wherein a single FD basis window length is common to each FD basis window of the plurality of FD basis windows.

Aspect 46: The method of any of Aspects 44-45, wherein each FD basis window of the plurality of FD basis windows has a respective length associated with the respective TRP.

Aspect 47: The method of any of Aspects 38-46, wherein the FD basis information includes a plurality of selected FD bases respectively associated with the plurality of TRPs, wherein one or more FD basis parameters are associated with the plurality of selected FD bases.

Aspect 48: The method of Aspect 47, wherein the configuration information includes an indication of the one or more FD basis parameters.

Aspect 49: The method of either of claim 47 or 48, wherein the one or more FD basis parameters indicate a quantity of FD bases common to all of the TRPs of the plurality of TRPs.

Aspect 50: The method of any of Aspects 47-49, wherein the one or more FD basis parameters indicate a quantity of selected FD bases associated with each TRP of the plurality of TRPs.

Aspect 51: The method of any of Aspects 47-50, wherein the one or more FD basis parameters indicate a maximum quantity of selected FD bases associated with a TRP of the plurality of TRPs.

Aspect 52: The method of Aspect 51, wherein the FD basis information indicates a quantity of selected FD bases associated with each TRP of the plurality of TRPs.

Aspect 53: The method of any of Aspects 47-52, wherein the one or more FD basis parameters indicate a maximum quantity of selected FD bases associated with the plurality of TRPs.

Aspect 54: The method of any of Aspects 38-53, wherein the FD basis information indicates at least one FD basis associated with a TRP of the plurality of TRPs, and wherein the at least one FD basis is based on an FD basis window start position associated with an FD basis window, an FD basis window length associated with the FD basis window, and a quantity of selected FD bases associated with the TRP.

Aspect 55: The method of Aspect 54, wherein the at least one FD basis comprises a first FD basis occurring in the FD basis window after the FD basis window start position.

Aspect 56: The method of either of claim 54 or 55, wherein the FD basis information indicates the FD basis selection based on the at least one FD basis including two or more FD bases.

Aspect 57: The method of Aspect 56, wherein the FD basis information indicates a respective FD basis index associated with each of the two or more FD bases other than a first FD basis occurring in the FD basis window after the FD basis window start position.

Aspect 58: The method of any of Aspects 38-57, wherein the configuration information indicates quantities of selectable CSI-RS ports associated with respective TRPs of the plurality of TRPs.

Aspect 59: The method of any of Aspects 38-57, wherein the configuration information indicates CSI-RS resources associated with respective TRPs of the plurality of TRPs, and wherein quantities of selectable CSI-RS ports associated with respective TRPs of the plurality of TRPs are indicated by respective port quantity values.

Aspect 60: The method of any of Aspects 38-57, wherein the configuration information indicates CSI-RS resources associated with respective TRPs of the plurality of TRPs, and wherein quantities of selectable CSI-RS ports associated with respective TRPs of the plurality of TRPs are based on a port quantity value common to the plurality of TRPs.

Aspect 61: The method of Aspect 60, wherein the configuration information indicates quantities of ineffective ports associated with respective TRPs of the plurality of TRPs, and wherein the quantities of selectable CSI-RS ports associated with respective TRPs are based on the port quantity value and the respective quantities of ineffective ports.

Aspect 62: The method of any of Aspects 38-61, wherein the configuration information indicates a total quantity of UE-selected CSI-RS ports associated with the plurality of TRPs, and wherein the SD basis information indicates a selection value associated with selection of one or more CSI-RS ports associated with a TRP of the plurality of TRPs.

Aspect 63: The method of Aspect 62, wherein the configuration information indicates a quantity of UE-selected CSI-RS ports associated with each TRP of the plurality of TRPs, and wherein the SD basis information indicates a selection value associated with selection of one or more CSI-RS ports associated with each TRP of the plurality of TRPs.

Aspect 64: The method of any of Aspects 62-63, wherein the configuration information indicates a total quantity of UE-selected CSI-RS ports associated with the plurality of TRPs, and wherein the SD basis information indicates selection information associated with an allocation of the total quantity of UE-selected CSI-RS ports across the plurality of TRPs.

Aspect 65: The method of Aspect 64, wherein the selection information indicates a quantity of selected CSI-RS ports.

Aspect 66: The method of Aspect 64, wherein the selection information indicates a selection value associated with selection of a set of selected CSI-RS ports from among a set of CSI-RS ports associated with the plurality of TRPs.

Aspect 67: The method of any of Aspects 38-66, wherein the configuration information indicates a quantity of NZCs associated with the plurality of TRPs.

Aspect 68: The method of Aspect 67, wherein the configuration information indicates the quantity of NZCs based on indicating coefficient indication values associated with respective TRPs of the plurality of TRPs, wherein the NZC information indicates, based on the coefficient indication values, a position associated with each NZC associated with the plurality of TRPs.

Aspect 69: The method of any of Aspects 67-68, wherein the configuration information indicates the quantity of NZCs based on indicating a total coefficient indication value associated with the plurality of TRPs, wherein the NZC information further indicates, based on the total coefficient indication value, a position associated with each TRP of the plurality of TRPs.

Aspect 70: The method of any of Aspects 38-69, further comprising:

transmitting a sounding reference signal (SRS) configuration associated with at least one channel estimation of at least one uplink channel between the UE and at least one TRP of the plurality of TRPs; and receiving the SRS based on the SRS configuration, wherein the plurality of precoded CSI-RSs is associated with a set of SD precoding weights and a set of FD precoding weights, wherein each of the set of SD precoding weights and the set of FD precoding weights is based on the at least one channel estimation.

Aspect 71: The method of Aspect 70, wherein an FD precoding weight, associated with a TRP of the plurality of TRPs, of the set of FD precoding weights is based on a path delay associated with the TRP.

Aspect 72: The method of any of Aspects 70-71, wherein an FD precoding weight, associated with a TRP of the plurality of TRPs, of the set of FD precoding weights is based on a plurality of path delays associated with two or more TRPs of the plurality of TRPs.

Aspect 73: The method of Aspect 72, wherein a CSI-RS of the plurality of precoded CSI-RSs is associated with a dominant path associated with a TRP of the plurality of TRPs and is based on an FD precoding weight of the set of FD precoding weights.

Aspect 74: An apparatus for wireless communication at a device, comprising a processor; memory coupled with the processor; and instructions stored in the memory and executable by the processor to cause the apparatus to perform the method of one or more of Aspects 1-37.

Aspect 75: A device for wireless communication, comprising a memory and one or more processors coupled to the memory, the one or more processors configured to perform the method of one or more of Aspects 1-37.

Aspect 76: An apparatus for wireless communication, comprising at least one means for performing the method of one or more of Aspects 1-37.

Aspect 77: A non-transitory computer-readable medium storing code for wireless communication, the code comprising instructions executable by a processor to perform the method of one or more of Aspects 1-37.

Aspect 78: A non-transitory computer-readable medium storing a set of instructions for wireless communication, the set of instructions comprising one or more instructions that, when executed by one or more processors of a device, cause the device to perform the method of one or more of Aspects 1-37.

Aspect 79: An apparatus for wireless communication at a device, comprising a processor; memory coupled with the processor; and instructions stored in the memory and executable by the processor to cause the apparatus to perform the method of one or more of Aspects 38-73.

Aspect 80: A device for wireless communication, comprising a memory and one or more processors coupled to the memory, the one or more processors configured to perform the method of one or more of Aspects 38-73.

Aspect 81: An apparatus for wireless communication, comprising at least one means for performing the method of one or more of Aspects 38-73.

Aspect 82: A non-transitory computer-readable medium storing code for wireless communication, the code comprising instructions executable by a processor to perform the method of one or more of Aspects 38-73.

Aspect 83: A non-transitory computer-readable medium storing a set of instructions for wireless communication, the set of instructions comprising one or more instructions that, when executed by one or more processors of a device, cause the device to perform the method of one or more of Aspects 38-73.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

1. A user equipment (UE) for wireless communication, comprising:
at least one memory; and
at least one processor communicatively coupled with the at least one memory, the at least one processor operable to cause the UE to:
receive configuration information associated with reporting channel state information (CSI) associated with a plurality of transmission reception points (TRPs) for multiple TRP (mTRP) coherent joint transmission (CJT), the CSI including, for each of the plurality of TRPs, frequency domain (FD) basis information associated with a port selection codebook, spatial domain (SD) basis information associated with the port selection codebook, and non-zero coefficient (NZC) information associated with the port selection codebook;
receive a plurality of precoded channel state information (CSI)-reference signals (CSI-RSs) from the plurality of TRPs, wherein each of the plurality of precoded CSI-RSs is based on an SD precoding operation and an FD precoding operation; and
transmit a reporting communication based on the configuration information and the plurality of precoded CSI-RSs.

2. The UE of claim 1, wherein the reporting communication comprises an mTRP CJT CSI report including a further enhanced (Fe) Type-II port selection codebook.

3. The UE of claim 1, wherein the FD precoding operation is associated with an FD precoding mode associated with at least one path delay difference associated with at least one TRP of the plurality of TRPs, and wherein the reporting communication indicates the FD basis information, wherein the FD basis information is based on the FD precoding mode.

4. The UE of claim 1, wherein the FD basis information includes a plurality of selected FD bases associated with a plurality of FD basis windows, wherein each FD basis window of the plurality of FD basis windows is associated with a respective TRP of the plurality of TRPs.

5. The UE of claim 1, wherein the FD basis information includes a plurality of selected FD bases respectively associated with the plurality of TRPs, and wherein the at least one processor is further operable to cause the UE to obtain an indication of one or more FD basis parameters associated with the plurality of selected FD bases.

6. The UE of claim 1, wherein the FD basis information indicates at least one FD basis associated with a TRP of the plurality of TRPs, and wherein the at least one FD basis is based on an FD basis window start position associated with an FD basis window, an FD basis window length associated with the FD basis window, and a quantity of selected FD bases associated with the TRP.

7. The UE of claim 1, wherein the configuration information indicates a total quantity of UE-selected CSI-RS ports associated with the plurality of TRPs, and wherein the SD basis information indicates a selection value associated with selection of one or more CSI-RS ports associated with a TRP of the plurality of TRPs.

8. The UE of claim 1, wherein the configuration information indicates quantities of selectable CSI-RS ports associated with respective TRPs of the plurality of TRPs.

9. The UE of claim 1, wherein the configuration information indicates CSI-RS resources associated with respective TRPs of the plurality of TRPs, and wherein quantities of selectable CSI-RS ports associated with respective TRPs of the plurality of TRPs are indicated by respective port quantity values.

10. The UE of claim 1, wherein the configuration information indicates CSI-RS resources associated with respective TRPs of the plurality of TRPs, and wherein quantities of selectable CSI-RS ports associated with respective TRPs of the plurality of TRPs are based on a port quantity value common to the plurality of TRPs.

11. The UE of claim 10, wherein the configuration information indicates quantities of ineffective ports associated with respective TRPs of the plurality of TRPs, and wherein the quantities of selectable CSI-RS ports associated with respective TRPs are based on the port quantity value and the respective quantities of ineffective ports.

12. The UE of claim 1, wherein the configuration information indicates a quantity of UE-selected CSI-RS ports associated with each TRP of the plurality of TRPs, and wherein the SD basis information indicates a selection value associated with selection of one or more CSI-RS ports associated with each TRP of the plurality of TRPs.

13. The UE of claim 1, wherein the configuration information indicates a total quantity of UE-selected CSI-RS ports associated with the plurality of TRPs, and wherein the SD basis information indicates selection information associated with an allocation of the total quantity of UE-selected CSI-RS ports across the plurality of TRPs.

14. The UE of claim 1, wherein the configuration information indicates a quantity of NZCs associated with the plurality of TRPs.

15. The UE of claim 1, wherein the at least one processor is further operable to cause the UE to:
receive a sounding reference signal (SRS) configuration associated with at least one channel estimation of at least one uplink channel between the UE and at least one TRP of the plurality of TRPs; and
transmit the SRS based on the SRS configuration, wherein the plurality of precoded CSI-RSs is associated with a set of SD precoding weights and a set of FD precoding weights, wherein each of the set of SD precoding weights and the set of FD precoding weights is based on the at least one channel estimation.

16. The UE of claim 15, wherein an FD precoding weight, associated with a TRP of the plurality of TRPs, of the set of FD precoding weights is based on a path delay associated with the TRP.

17. The UE of claim 15, wherein an FD precoding weight, associated with a TRP of the plurality of TRPs, of the set of FD precoding weights is based on a plurality of path delays associated with two or more TRPs of the plurality of TRPs, and wherein a CSI-RS of the plurality of precoded CSI-RSs is associated with a dominant path associated with a TRP of the plurality of TRPs and is based on an FD precoding weight of the set of FD precoding weights.

18. A network node for wireless communication, comprising:
at least one memory; and
at least one processor communicatively coupled with the at least one memory, the at least one processor operable to cause the network node to:
transmit configuration information associated with reporting channel state information (CSI) associated with a plurality of transmission reception points (TRPs) for multiple TRP (mTRP) coherent joint transmission (CJT), the CSI including, for each of the plurality of TRPs, frequency domain (FD) basis information associated with a port selection codebook, spatial domain (SD) basis information associated with the port selection codebook, and non-zero coefficient (NZC) information associated with the port selection codebook;
transmit a plurality of precoded channel state information (CSI)-reference signals (CSI-RSs) from the plurality of TRPs, wherein each of the plurality of precoded CSI-RSs is based on an SD precoding operation and an FD precoding operation; and
receive a reporting communication based on the configuration information and the plurality of precoded CSI-RSs.

19. The network node of claim 18, wherein the reporting communication comprises an mTRP CJT CSI report including a further enhanced (Fe) Type-II port selection codebook.

20. The network node of claim 18, wherein the FD precoding operation is associated with an FD precoding mode associated with at least one path delay difference associated with at least one TRP of the plurality of TRPs, and wherein the reporting communication indicates the FD basis information, wherein the FD basis information is based on the FD precoding mode.

21-32. (canceled)
